(19) United States
(12) Patent Application Publication
(10) Pub. No.: US 2023/0134651 A1
(43) Pub. Date: May 4, 2023

(54) Synchronized Identity, Document, and Transaction Management

(71) Applicant: Akporefe Agbamu, Oakdale, MN (US)

(72) Inventor: Akporefe Agbamu, Oakdale, MN (US)

(21) Appl. No.: 17/512,679

(22) Filed: Oct. 28, 2021

(51) Int. Cl. G06Q 50/26; G06V 30/19; G06V 40/16; G06V 10/82; H04L 9/40; G06K 19/06

(52) U.S. Cl. CPC G06Q 50/265; G06V 30/191; G06V 40/172; G06V 10/82; H04L 63/0876; G06K 19/06037

(57) ABSTRACT

A passwordless computer system for automated identity, document, and transaction management, enabling onboarding, compliance workflow, and client lifecycle management includes a biometrics system of supervised and/or unsupervised intelligence. The system may support various biometrics types, preferably utilizing facial biometrics comparison for compliance onboarding. Images compared may be an image/recording of an identification card, credentials being physical and/or digital; gender, age, ethnicity, anti-spoofing, liveness component being present. An authentication system utilizing authentication server(s) that may upon request send a nonce to another system, devices, applications, etc. Utilizing biometrics for validating and unlocking private keys to sign a nonce, and communicating with the authentication server(s) for private and public key validation, and an access token(s).

### CROSS-REFERENCE TO RELATED APPLICATIONS

This application claims priority under 35 USC § 119 to U.S. Provisional Patent Application No. 63/105,881, filed on Oct. 27, 2020. The disclosure is included herein in its entirety at least by reference.

### BACKGROUND OF INVENTION

### Field of the Invention

The present invention is in the field of onboarding and client lifecycle management systems, and pertains particularly to systems for identity, document, transaction management.

### Discussion of the State of the Art

In the art of onboarding and client lifecycle management, more particularly for businesses and governments (entities), verifying the identity of individuals and businesses (users) is fundamental and mandatory. This verification process is otherwise referred to as Know Your Customer (KYC), Know Your User (KYU), Know Your Business (KYB), and/or Anti-Money Laundering. Once an individual or business identity and background check has been verified (rejected), there is typically a document (contracts) exchange process linked to the onboarding and client lifecycle phases. Post onboarding and during the client lifecycle, various transaction types may be executed, monitored, and tracked (audit trails), and then reported to different reporting authorities. Data related to those events is subsequently stored to meet regulatory retention requirements.

One problem with traditional onboarding and lifecycle management systems is that systems are fragmented. In addition, current solutions focus only on identity and/or transaction management; or identity and/or document, but fail to provide an integrated solution for identity, document, and transaction management. Nor do they handle the bi-products of identity, document, and transaction management—reporting and data retention. As a result, entities are forced to use multiple solutions from various vendors for onboarding and client lifecycle management. Leading to siloed audit trails (if they exist at all) and cumbersome processes for data reconciliation.

Another limitation of current onboarding and client lifecycle management systems is that many use traditional passwords for authentication. Compromised passwords cause ˜80% of data breaches. By eliminating traditional passwords and replacing them with biometric authentication and layering in multi-factor authentication (MFA), the surface area for breaching systems, applications, devices, and networks is greatly reduced. Moreover, biometric authentication can be used for other verifications during the clients' lifecycle to improve the customers' experience and systems security.

Therefore, what is clearly needed in the art is a passwordless integrated onboarding and client lifecycle systems. Such a system is disclosed and claimed herein

### SUMMARY OF THE INVENTION

In one embodiment of the invention a passwordless computer system for automated onboarding, compliance workflow, and client lifecycle management is provided, comprising a biometrics system of supervised and/or unsupervised intelligence, said system may support various biometrics types, preferably utilizing facial biometrics comparison for compliance onboarding, image compared may be an image/recording of an identification card, credentials being physical and/or digital, gender, age, ethnicity, anti-spoofing, liveness component being present, a passwordless authentication system utilizing authentication server(s) that may upon request send a nonce to another system, devices, applications, utilizing biometrics for validating and unlocking private keys to sign a nonce, communicating with the authentication server(s) for private and public key validation, access token(s), a multi-factor authentication system comprising QR codes, PIN codes, links, etc. may be sent via SMTP and/or SMS, an account authentication and monitoring system leveraging supervised and/or supervised algorithms, wherein additional system(s) generate IP location, VPN, device classification, cookies information, for grouping, bundling, clustering, thwarting threats, an identification authentication system utilizing security features comprising UV, infrared, holograms, watermarks unique to a specific ID type may be learned, enabling classification and validation, securing the credibility of authentication/onboarding processes, an optical character recognition (OCR) system utilizing at least one neural network, line recognition and character recognition may be present, enabling information to be extracted from documents/identification, optionally queried against compliance databases, auto-filling documents fields, linked to an e-signature and transfer system, a barcode scanner system where codes comprising PDF417, QR code, code 128, code39, EAN 8/13, UPC A/E may scan and extract information, optionally queried against AML/KYB/PEP databases, auto-filling documents fields, linked to an e-signature and transfer system, a country risk score system utilizing variables that may be comprised from the Financial Action Task Force (FAFT) in gauging AML risk, country risk scores and individual risk score(s), said system optionally using algorithms of the machine artificial intelligence in adjusting risk scores for classifying and predicting compliance risks, a credentials updating system, optional enabling users to reset biometric signature manually, said system may also refresh authentication credentials over a fixed, predetermined, random time, continuously providing robust authentication services, an alert system wherein real-time and/or rules-based alter system may be present, empowering timely response and/or notification, optionally integrated with a transaction monitoring system, a virtual private network, that may use connector(s) to provide encrypted access to the network preferably at all endpoints, and a storage system, enabling storage on centralized and/or distributed systems.

In one embodiment of the invention, web crawlers and cronjobs may be used to scrap websites and update AML/KYB/KYC database(s) automatically. In another embodiment of the invention, a private, consortium, public blockchain is present, a hash of onboarding data may be saved on-chain, preferably storing sensitive information off-chain. In another embodiment of the invention, a transaction monitoring system (TMS) capable of detecting different typologies and mitigating false positives via machine intelligence is utilized, optionally storing transaction data (or a hash of data) on-chain and/or off-chain, transactions thresholds may trigger automatic regulatory reporting. In another embodiment of the invention, employing an electronic file transfer/signature system, sending current and prospective client(s) documents, optionally enabling signature, said system(s) preferably leveraging IP location, VPN, device classification, for authentication and system learning.

### BRIEF DESCRIPTION OF THE DRAWING FIGURES

Illustrative, non-limiting exemplary embodiments may be more clearly understood from the following detailed description, particularly when taken in conjunction with the accompanying drawings, in which:

FIG. 1 is an architecture diagram illustrating an identity management system according to an embodiment of the present invention.

FIG. 2 is a flow process depicting a facial recognition pipeline according to an embodiment of the present invention.

FIG. 3 is a process flow chart depicting an identity management system according to an embodiment of the present invention.

FIG. 4 is a flow process depicting the onboarding process according to an embodiment of the present invention.

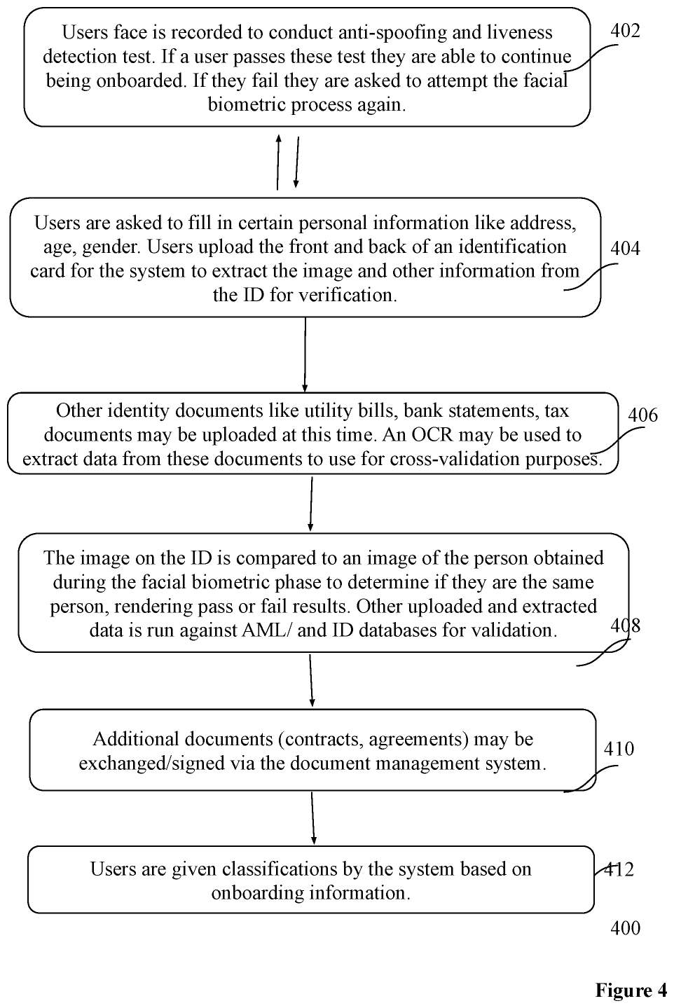

FIG. 5 is a process flow chart depicting passwordless authentication systems according to an embodiment of the present invention.

FIG. 6 is a flow process depicting passwordless authentication systems according to an embodiment of the present invention

FIG. 7 is an architecture diagram illustrating document management systems according to an embodiment of the present invention.

FIG. 8 is a process flow chart depicting identity and document systems according to an embodiment of the present invention.

FIG. 9 is a flow process depicting biometric e-signature and file transfer systems according to an embodiment of the present invention.

FIG. 10 is a process flow chart depicting identity, document, and transaction management systems according to an embodiment of the present invention.

### DETAILED DESCRIPTION

The inventor provides a unique passwordless onboarding and lifecycle management system comprising identity, document, and transaction management, that automatically creates audit trails and reconciles data, streamlines reporting and data storage, throughout the onboarding process and client lifecycle. Thus enabling entities to streamline onboarding and client lifecycle compliance functions, while mitigating fraud and breach-related activity. The following descriptions of the embodiments of the disclosed invention are not intended to limit the invention to these preferred embodiments but rather to enable any person skilled in the art to make and use this invention. The present invention is described in detail in the following examples, which may represent more than one embodiment of the present invention.

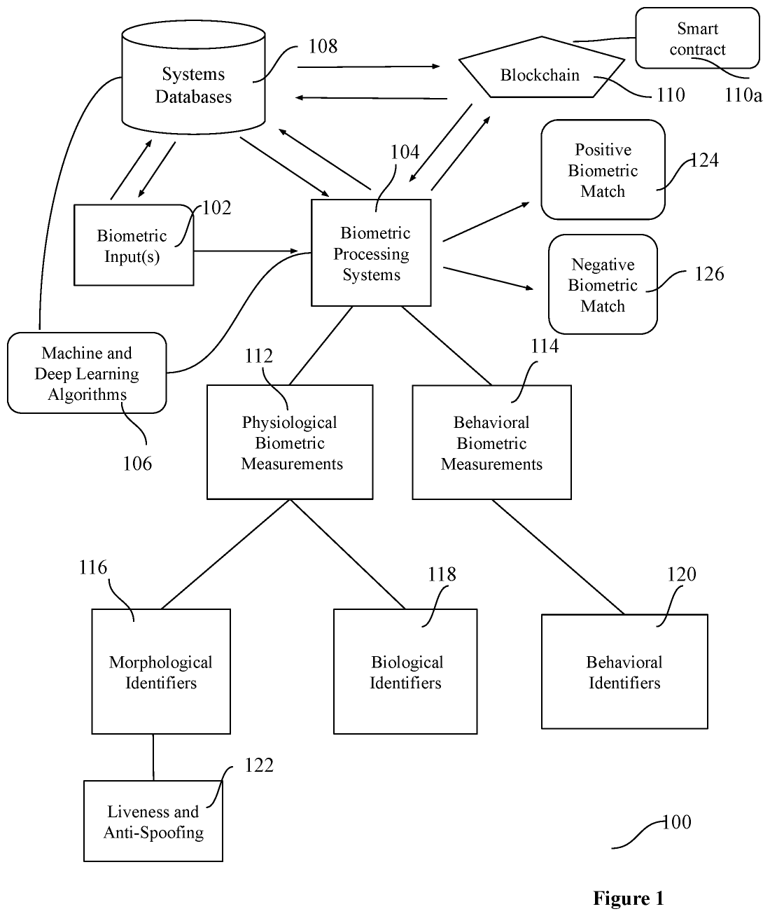

Referring to FIG. 1 is an architecture diagram illustrating an identity management system according to an embodiment of the present invention. In certain exemplary embodiments of the present disclosure is an identity management system 100 that may be driven by a biometrics system(s) 104 utilizing convolutional neural networks 106, preferably incorporating multiple layers and parameters. Biometrics systems 104 may be pre-trained, learning over predetermined intervals, or continuously. The biometric capabilities 104 of the identity management system 100 may utilize morphological identifiers 116 like a face 102, to enable vector representations to be compared for facial verification 124-126 purposes. The Euclidean distance between two vectors may be utilized for n-dimensional vectors to find facial similarities 124. False positives may be mitigated via optimization of factors comprising the threshold function, F1 score, precession, and recall.

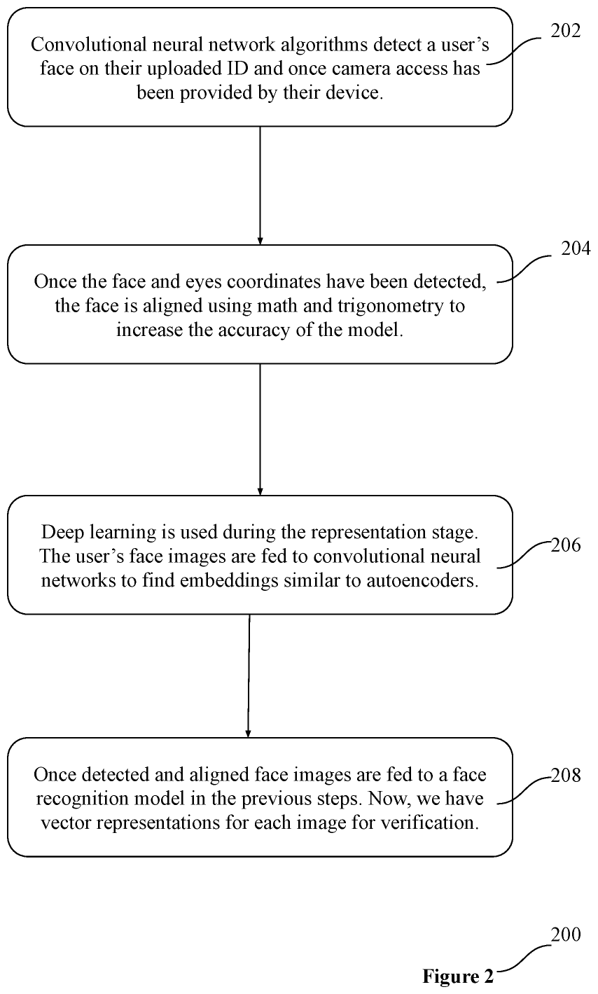

Referring to FIG. 2 is a flow process depicting a facial recognition pipeline according to an exemplary embodiment of the present invention 200 that may progress via detection 202, alignment 204, representation 206, and verification 208 phases. The present inventive disclosure may leverage algorithms of supervised and/or unsupervised intelligence 106, including but not limited to, convolutional neural networks and autoencoders to process images/videos 102. The deep learning 106 algorithms used by the biometric system 104 for detection 202 may comprise haar cascade, single shot multibox detector, histogram of oriented gradients, max-margin object detection, and multitask cascaded convolutional networks.

The present invention may contain detection 202 and alignment 204 algorithms for face and eye detection and alignment, enabling the facial recognition 112 capabilities of the biometric system 104 of the present disclosure to transition to a representation phase 206 where face images 102 may be consumed and processed by convolutional neural networks 106 or other forms of deep learning for verification 208. Deep learning models 106 of the present identity management system 100 may be supportive of different input shapes and types 102, yielding vector representations 208 per image. 1D vectors may be transformed into 2D matrices by appending said vectors. Ensuring that each line of the matrix may contain similar attributes and variables, reaching a determination on whether two (or more) images may be the same person 124, based on said vector representations 208 relative to facial depictions 102.

In exemplary embodiments of the present inventive disclosure, liveness and anti-spoofing 122 measures may be found, spurring the identity management system 100 of the present invention to dynamically and accurately ascertain whether there is facial similarity 124-126 and mitigate false positives. Additional benefits of preferred embodiments of the present disclosure may be liveness/anti-spoofing methods 122 comprising, singularly or in combination, user prompts and indicators for facial expressions (smiling, laughing, crying, blinking), audible responses (alphabet, 1-10, full name), hold something (written text, QR code) to protect the integrity of facial biometric output 124-126 of the identity management system 100 of the present invention.

The present inventive disclosure may accept biometric input 102 as still images, or video recordings that may be subsequently broken into still images or frames. The present disclosure may be used to authenticate and validate age, gender, and ethnicity, to determine whether a user is of the stated or implied age, gender, or ethnicity. Helping to increase the efficacy and/or confidence threshold of output 124-126 derived from the system of the present invention.

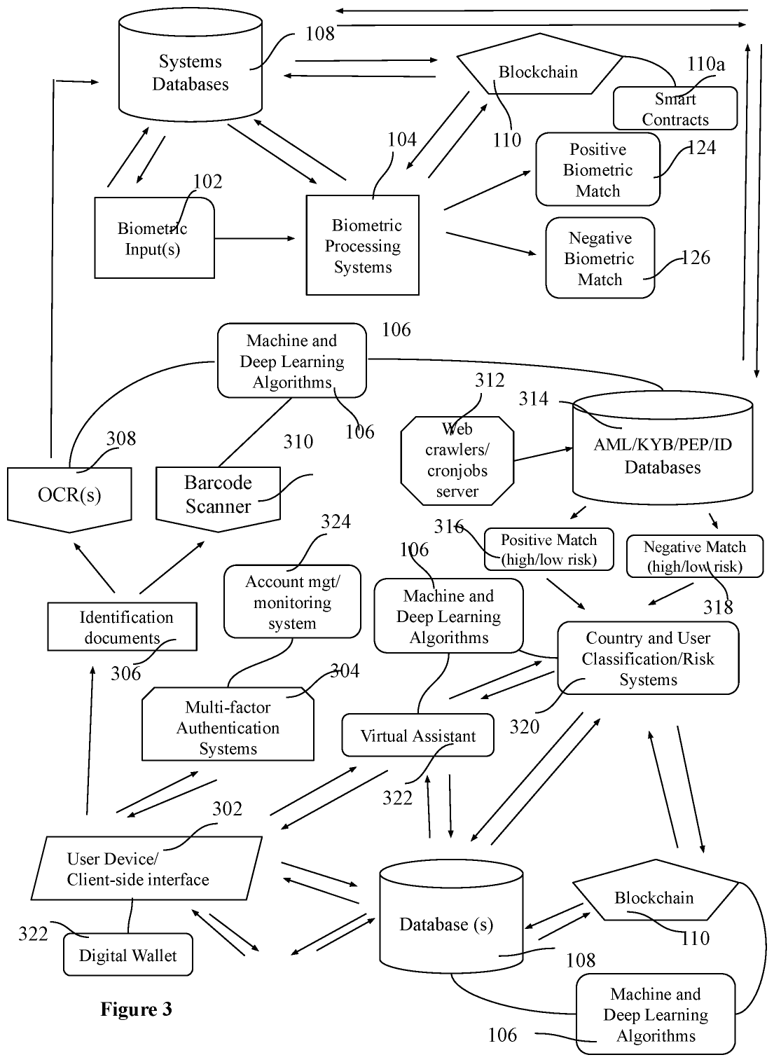

Referring to FIG. 3 is a process flow chart depicting an identity management system according to an exemplary embodiment of the present invention. In preferred embodiments of the present invention, the user's facial recording/image 102 may be processed 104 and compared to the facial image contained on an identification card 306 uploaded to the system via the client-side interface 302 via API. The system may then detect 202 and extract the user's face from their ID 306 (physical, digital, virtual), in addition to other sensitive information contained on the ID 306.

The ID 306 types the system can detect and extract 308-310 information from passports, identity cards, driver's licenses, residential permits, and visas. The biometric processing system 104 may preferably compare the two images, real-time image 102 and image from ID 306 to determine if there is a ‘match’ 124. The ‘match’ 124 threshold of the biometric system 104 may be set and adjusted to provide optimal results, without limitation. Whereas the closer the distance between the real-time image 102 and image from ID 306 are, the more likely a ‘match’ 124.

APIs and/or SDKs may be used for communicating between the client-side interfaces 302 (iOS/Android/Desktop/Mobile) recording and retrieving the facial biometric 102 information, and the server-side systems processing 104 and storing the biometric information 108-110. APIs may also be used to send biometric inputs 102 to the backend 104 for the processing of biometric inputs 102. Results 124-126 of biometric analysis may be communicated via API calls to seed the database(s) 108 and the client-side application 302 and to 3rd party systems that utilize and/or store data.

In exemplary embodiments of the present inventive disclosure, the identification card(s) 306 may be used as an initial source of truth. The identity management system 300 may utilize facial biometrics 102 and algorithms of the machine/deep intelligence 106 to ascertain the likelihood that the video recording/still image 102 and image from an identification card 306 is positive 124 or negative 126 for authentication and verification. When authenticating and validating IDs 306, the identity management system 300 may fetch IDs from databases 314 (internal or 3rd party) via API, optionally caching images for optimal retrieval and system performance.

The database(s) 314 may classify IDs 306 by variables comprising country name, state name, ID type, ID name, security features, valid or invalid, and version type. This may enable the identity management system 300 to determine the authenticity of identity documents 306 being uploaded, and compare the real-time biometrics 102 of a user to the image 102 on an identification card 306 for biometric verification 124-126. Certain preferred embodiments of the present invention may provide score(s) 320 to express whether a document uploaded is authentic 316 or inauthentic 318. The ID database(s) 314 of the system 300 may be used for manual comparison and queried via API directly, and by using the client-side interface 302 of the system 300. APIs and/or SDKs may be used for communicating between the client-side interface 302 uploading the identity card 306 and the server-side systems 106 processing the retrieved information. Results 316-318 of identity card 306 analysis may also be communicated via API to seed DBs 108 which display results in the client-side application 302.

A benefit of exemplary embodiments of the present invention is a system 300 that may utilize optical character recognition (OCR) 308, which may preferably be enhanced with intelligence of supervised and unsupervised nature 106, to aid in identifying regions on uploaded identity documents 306. For the purpose of extracting and synthesizing information for authentication, validation, verification, and classification purposes of the identity management system 300.

In an example of an exemplary embodiment of the present invention, a user may take a picture, video record, screenshots, or scan their ID 306 via the client-side application(s) 302 and capture the front, and optionally, the back of identification cards 306 for analysis. Information extracted via OCR 308 or barcode scanner 310 from identification cards 306 may be compared to previous or forthcoming data 102 provided for authentication, verification, and validation. The user may upload additional documents 306 like utility bills, bank statements, and tax returns for capture to positively authenticate 124/316 themselves.

Regressions 106 may be used to spatially separate bounding boxes and associated class probabilities. Single or multiple neural networks 106 may predict bounding boxes and class probabilities from ID 306 images 102 in single or multiple evaluations. The architecture of certain exemplary embodiments of the present system 300 may enable images 102 to be processed 104 in real-time or in batches once uploaded. The present invention may use single or multiple cores for processing 104 biometrics 124-126 and identity 316-318 results. The identity management system 300 may be deployed directly onto servers or via docker containers that run the system 300 within containers that are deployed on the server. In other exemplary embodiments, the system 300 may preferably utilize no CPUs utilizing GUNICORN or the like, wherein GUNICORN may be deployed inside the docker container.

In certain exemplary embodiments of the present invention, the identity management system 300 may use object detection models 106 for the classification of different categories of identification documents 306. Models 106 may detect the identity document 306 and pass the cropped document 306 for processing 308-310. The ID image 306 may be rotated clockwise or counter clockwise to an angle of ‘0’ degrees, better enabling deep learning models 106 to be trained. A function may unshear the image using different logical functions and mathematical formulas like OpenCV, providing a cropped image of document 306.

The identity management system 300 may use another detection model 106 (YOLO, MRCNN, UNET) that will be trained to detect the MRZ or barcodes from documents 306. Thereafter the MRZ may be cropped and sent to another model 106 for further processing. To improve the algorithm's 106 detection accuracy of the MRZ 306 text, the background may be removed from image 306, utilizing different filters and techniques (UNET, MRCNN, dilation, erosion) to enhance the image 306 texts. For text detection and recognition, an OCR model 308 may be applied to the image. The MRZ text from the document 306 image may be extracted, processed, parsed, and interpreted.

ID 306 information comprising first and last name, ID number, date of birth, expiration date, and MRZ, may be extracted from identity documents 306 by identifying regions of interest via an embodiment of the present inventive concept. Neural network(s) 106 with multiple layers may be used for single object and image detection and classification, and multiple objects and image detection classifications. The document OCRs 308 of the present system may preferably be multilingual, spurring usage across different countries and territories identification documents 306. In addition, the present system may support various output formats like plain text, hOCR (HTML), PDF, invisible-text-only PDF, j son, and TSV.

The system may utilize deep learning algorithms 306 to dynamically identify Machine Readable Zone for official travel documents 306 sizes 1, 2, 3, MRVA, and MRVB (passports, visas, national id, other travel documents). Identity document 306 information comprising document type, country code, document number, surname, and given name may be extracted via OCR 308. Information extracted may be compared to previous or forthcoming data provided by users, or gleaned by the system for authentication, verification, and validation.

In other exemplary embodiments of the present inventive disclosure, barcode(s) at the back of the identification documents 306 may also be captured, uploaded, scanned, observed, and interpreted by the barcode scanner(s) 310 utilized by the identity management system to extract information and authenticate 316-318 it against AML, KYB, PEP, and ID databases 314. Machine-readable technology 310 supporting two-dimensional barcode symbology may be present. Barcode recognition and interpretation systems 310 may be utilized for decoding various barcode types, including but not limited to PDF417 symbology, before subsequently parsing the barcode into human-readable formats. The present invention may leverage QR codes to move users between various client-side interfaces 302 (mobile/desktop) when a certain device (ex: phone vs desktop) may provide a better user experience for onboarding processes and flow.

Data extracted from identity documents 306 may be used to auto-populate forms and contracts in the document management systems of the present disclosure via API to limit human error associated with manual data entry. Furthermore, information extracted may be transmitted and stored in centralized databases 108, CRMs, or decentralized/distributed storage 110. Extracted information and document verification results may be stored within the databases 108 (SQL/NoSQL) of the present invention, and visualized via the client-side application 302 of the system. All data within the system is preferably encrypted at rest and in transit for optimal security.

In certain preferred embodiments of the present invention, to ensure the authenticity of identification documents 302 submitted during onboarding, and throughout the client's lifecycle, the present disclosure having been trained via methods of machine (deep) intelligence 106 may look for security features, watermarks, holograms, infrared, and UV features unique to each identification type 306 to ensure the quality and validity 316-318 of identification documents 306 referenced during onboarding and future authentications. Certain embodiments of the present invention may use tools like NFC passport readers to verify the RFID chip embedded in electronic passports, national identity cards, and other International Civil Aviation Organization (ICAO) compliant identity documents. Other security checks, comprising Active Authentication, Chip Authentication, Passive Authentication may also be conducted.

A benefit of preferred embodiments of the present disclosure is a system where OCRs 308 may be used for extracting the additional information during onboarding or at any time during the client lifecycle, from identity documents 306 comprising utility bills, bank statements, and tax returns. This may enable entities using the present system to seamlessly extract information for the auto-population of other forms, databases, and 3rd party systems via API, substantially limiting cumbersome and error-prone data entry processes, thus improving efficiency. In addition to further validating information from other identity documents 306 processed by the system. Dynamically querying users for input and making corrections. Preferably learning from corrections and errors over intervals or continuously, creating a smarter system.

In exemplary embodiments of the present invention, information extracted or manually entered during the onboarding and lifecycle process may be stored 108 by the system and fetched or transmitted via API, to be queried against AML and background check database(s) 314. Wherein background databases may utilize search-based databases like elastic search to store information. Preferably indexing information by data type or category, adding initial values in the beginning of an index to search all of the indexes simultaneously. Databases 314 comprising international and domestic (US) sanction list and blacklist, politically exposed persons, criminal background, eviction background, personal/business credit, adverse media, and sexual offenders databases may be observed to determine the risk 320 of users.

Database(s) 314 information queried may be internal and/or external databases. Allowing the system to perform exhaustive searches to help accurately assess user(s) risk 316-318. A primary reason for conducting onboarding is to ensure that entities know the individuals and businesses they interact with to adequately assess the risk 316-318 of servicing said individuals or businesses. The present invention may seek additional verification and authentication processes to provide additional data points for the system to learn via means of machine and artificial intelligence to increase the degree of certainty of risk 320 classifications.

Web scraping 312 and other programmable means of data aggregation may be used to effectively aggregate and parse data from AML list, sanction list, blacklist, adverse media, politically exposed persons (PEP), to be stored by the system's database(s) and utilized by the present disclosure via API. The present invention may leverage cronjobs 312 to automate the intervals in which data is collected 312 and stored 314. A benefit of an embodiment of the present system is an invention that may scrap/crawl 312 data in real-time, continuously updating the system's database(s) 314, preferably using hashing algorithms like MD5 and SHA-256 to create a hash of data stored. This may help ensure the database(s) 108-110 of the system is not storing duplicate entries, and subsequently removing any duplicates that may occur. The web crawlers 212 may optionally be run via a docker container on the server.

In exemplary embodiments of the present invention is a system that classifies 320 and categorizes users based on the information that was disclosed (discovered) during the onboarding process. Classification 320 categories may be determined by variables comprising country risk, user risk, credit risk, rent payment status, investment tolerance, and business type. The various classifications 320 and categories types may be expanded or reduced at any time, without limitation. Furthermore, users may be given multiple classifications 320 or have classification within classifications (subclassifications), without limitation. Classification types 320 and data used to derive them may also be retrieved via 3rd party API (ex: credit scores), or by fetching via API from the systems databases 108/314.

For example, users successfully onboarded may be classified 320 by the system as being simplified, standard, and enhanced due diligence cases. Users classified as ‘simplified’ may be of little risk, those classified as ‘standard’ of neutral risk, while ‘enhanced’ users may be of high risk. A benefit of the present inventive disclosure is a system where users may be classified 320 numerically, for example, 1-5. Classification 320 may be contingent on the entity utilizing the platform.

For example, a landlord may classify users by credit risk and rent paid status. A DMV may classify users by location (proximity to DMV) risk and driving (record) risk. An insurance company may classify users by age, gender, and health risks. A social media company may classify user risk by their country or platform consumption and usage. Decentralized trading or lending platforms may classify users based on on-chain, off-chain financial data, and user location. Depending on a user's classification(s) 320, the present system or compliance and onboarding personnel utilizing the present system may determine that a user being onboarded is safe to use the entities services/access, utilize the services/access in a limited capacity, provide additional information to get a better understanding of the risk(s) 320 profile, or prevent/restrict the user's access completely. Machine and deep learning algorithms 106 may be used to provide data-driven scores 320, optionally providing classifications 320 expressed in quintiles, deciles, etc.

Utilizing supervised/unsupervised deep learning algorithms 106, the present invention may develop and acquire knowledge (real-time, hourly, daily, weekly) to optimize participant results and risk assessment capabilities of the identity management system, accordingly. Deep learning algorithms 106 like neural networks, autoencoders, and Boltzmann machines may learn over predetermined or organic intervals from various inputs, including but not limited to IP location, device classification, country location, country risk score, credit score. The classification 320 of variables considered and derived by the systems of the present invention may be single and/or multi-factor variables. An advantage of the present invention is a system that may employ algorithms 106 to optimize classifications 320 via dynamic layers, characteristics, and variables of a specific user relative to a group of similar users based on a likely or unlikely set of variables.

In certain exemplary embodiments of the present disclosure, country scores 320 may be provided to accurately gauge the risk of the company's client base by country. During onboarding, specifically, onboarding pertaining to financial institutions, the country of residence or citizenship for a user may be the largest determinant of whether an entity may provide financial services to an individual or business. This may be because sanctions and other blacklists are placed on the country (ex: Iran) by another country (ex: U.S.) or global organization (ex: World Bank). Making it nearly impossible for entities in the sanctioning country, or in the jurisdiction of a country who abides by the sanctions of a sanctioning country or a sanctioning body, to do business with individuals and businesses from the sanctioned country. This lack of access to capital and financial institutions further drives the sanctioned country/entities to find covert ways to move assets and do business outside of their borders. Further opening-up any entity onboarding users to be a conduit for money laundering or other nefarious activities that may be associated with said country or individuals and business from said country. Especially if the said user was a politician or businessman (PEP/KYB).

Certain exemplary embodiments of the present system may utilize logically learned 106 systems to identify, collate, bundle, or otherwise package 320 a universe of countries, territories, individuals based on factor outcomes of ranked countries, territories, individuals. Thereby providing a system utilizing machine intelligence 106, sorting, or ranking as a process or system based on said classification 320 and ranking for the effective and beneficial variables. These attributes may be selected or derived from an unlikely or likely set of variables including but not limited to money laundering/terrorist financing risks, email verified, phone number verified, facial recognition score, age verified, gender verified, and the country score for an individual. These attributes may suitably become the key determinants of classifications and segmentations. The management or finessing of these attributes, optimizing the appropriate attribute under set circumstances, provides the ability to rank individuals and countries within a universe of individuals and countries without limitation.

In another exemplary embodiment of the identity management system of the present invention, single or multiple fingerprints 102 may be utilized in the commission of biometric authentication 124-126 processes for onboarding. Attributes, characteristics, and qualities of the fingerprint 102 may appear as a series of dark lines that may represent the high, peaking portion of the friction ridge skin, while the valley between said ridges may appear as white space and the low, shallow portion of the friction ridge skin.

Fingerprint 102 identification may be based primarily on the minutiae, or the location and direction of the ridge endings and bifurcations along a ridge path. An advantage of certain embodiments of the present inventive concept, optical sensors, or the user's device 302 may be used to take an image of the fingerprint. Holistic in nature, the present invention may utilize a variety (singular or in combination) of sensor types—optical, capacitive, ultrasound, and thermal, for collecting the digital representation of a fingerprint surface. Matching techniques comprising minutiae-based matching and pattern matching may be observed.

Another benefit of the present invention is a system that may compare a user's fingerprint 102 to a stored 108 fingerprint image or template to validate 124-126 a user's identity for access, authentication, validation into devices, systems, applications, databases, networks. Given their unique nature, fingerprint scans 102 are inherently distinct, making them impossible to guess and hard to fake and alter. In another embodiment of the present inventive concept a client may capture multiple fingerprint templates and use a PIN or another form or combination of multifactor authentication for enrollment.

Biometric 102 templates, images, depictions collected during onboarding may be encrypted and stored using centralized 108 or decentralized 110 means of data storage. In addition, a hash containing unique details of the biometrics 102 may be stored 108-110. In certain embodiments of the present system, where privacy concerns are an issue or need to meet certain requirements, biometrics images 102 and their derivatives may be stored locally 302 on a user's device and preferably encrypted.

A benefit of certain embodiments of the present invention is an identity management system that may use morphological 116 or biological 118 biometrics identifiers. Morphological 116 identifiers comprising face, fingerprints, finger/hand shape, eye (retina and iris), vein pattern, may be used; or biological biometrics comprising DNA, blood, saliva. Behavioral identifiers 114 may also be leveraged, including but not limited to keystroke dynamics and signature dynamics like speed of the pen/typing, and the pressure exerted inclination. An advantage of the present invention is a system that enables software and hardware (utilizing software) to capture instances of biometric verification 124-126. Enabling users of the present disclosure to access accounts, devices, applications, databases, and servers in a variety of different use cases across a multitude of industries for internal or external usage.

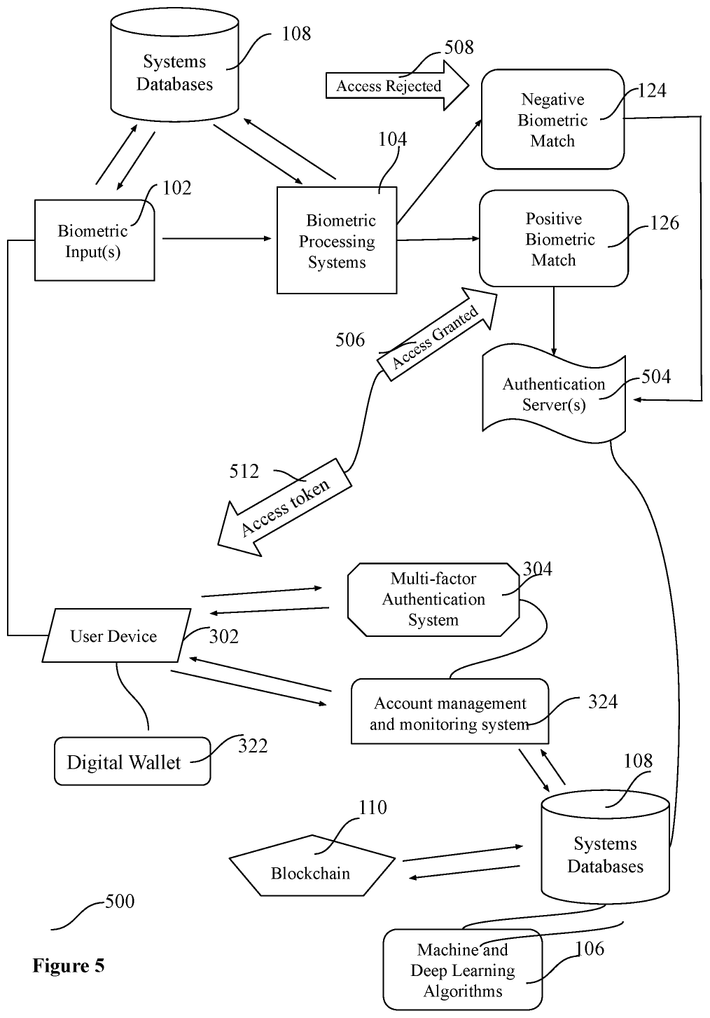

Referring to FIG. 5 an advantage certain preferred embodiment of the present invention is that a combination of biometric and multi-factor biometric authentication may be employed to provide users of the present disclosure access 506-508 to devices, systems, applications, servers; or to execute 506-508 certain sensitive functions and processes. Biometric 102 combinations like facial and fingerprint, facial and voice, fingerprint and voice, voice and keystroke dynamics, may be utilized, illustrating the dynamic and unique nature of the present invention. A benefit of certain embodiments of the present invention is the layering and grouping of biometric 506-508 authentication methods with traditional multi-factor authentication (MFA) 304, like email and SMS, or the combination of biometric authentication 508 methods, and traditional multifactor authentication 304 like google authenticators, smart cards, and active directories.

In certain preferred embodiments of the present inventive concept, passwordless authentication 500 may be present, leveraging biometrics 102 (facial, fingerprint, voice, retina) to provide access 508 or enable certain actions or functions within a device, system, application, database, or network. Biometric data 102 or hashes of biometric data 102 collected, extracted, requested, queried, and imported during the onboarding phase may be stored via distributed ledger (blockchain) 110, centralized systems 108, or locally on a user's device 302. The present inventive concept may be utilized for creating and training logically learned systems 106 to identify, analyze, and verify biometric input 102 used for authentication 506-508 and verification 124-126 purposes. The identity management of the present invention may be used for extracting 308-310, processing 104, and storing 108-110 identity 306 and biometric data 102 for future consumption 500 and authentication 506-508 by devices, application, device, system, network.

Biometrics 102 and various algorithms of deep learning 108 may be present, enabling the passwordless authentication system to gauge the accuracy, precision, and exactness of a user's facial biometrics 102 to a known source (or derivative) truth 306. These attributes may be collected from an unlikely or likely set of variables including, not limited to facial attributes 102 comprising nose shape, eye width, skin tone, age, and gender. The management or finessing of these attributes, optimizing the appropriate attribute under set circumstances provides the ability to authenticate 506-508 a user for access into a system, device, application, or meet any other objectives aligned with the system, device, application, databases functionality, and usability.

A benefit of the present disclosure is a system that may preferably lack the need or use conventional passwords. Biometric data 102 may be specific to an individual user and validated against a source of truth 306 (passport, driver's license, national ID), whether it be the initial capture 308-310, biometrics 102 stored in the system's database(s) 108-110, transferred from another database 314, or stored on a user device 302. Databases may be centralized 108 or decentralized 110 in nature, schema or schema-less, on-premise, or in the cloud, as need be.

The present inventive concept is one where access may not be granted or denied based on passwords being guessed, being misplaced, or forgotten. Biometrics 102 may turn into a strong credential system, allowing users to sign in via MFA 304 like push notification, SMS, OTP, PIN, email; and use biometric 102 (fingerprint, face, voice), or a combination of biometric 102 and traditional MFA authentication 304 methods. This presents a more secure and unique method of authentication 506-508 with the system or other systems using the authentication 506-508 capabilities of the system, during the clients' lifecycle, whether online or offline.

A benefit of certain embodiments of the present disclosure is a system that may enable users to perform facial biometrics 102 for access 506 to things on their local device 302 like a digital wallet. The biometric data 102 may be stored 108-110, 302 as a cryptographic hash instead of storing 108-110, 302 the original biometric images/videos 102. This hash may preferably be associated with a public key that may provide an authentication token 506 by a positive biometrics 102 match of the user. The biometric 102 data or hash may be stored within a digital wallet 510 and used for various purposes by the system, by systems and applications that leverage the Application Programming Interfaces (APIs) and Software Development Toolkits (SDKs) of the system.

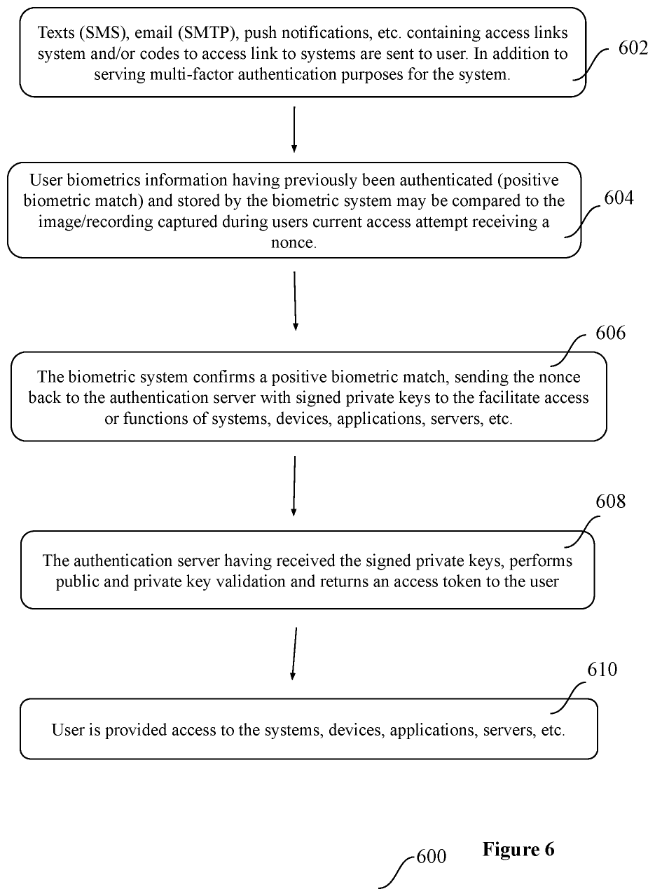

Referring to FIG. 6. a process flow chart, in certain embodiments, the passwordless authentication system 600 may authenticate users without leveraging the biometrics. Instead, authenticating via methods 304 like sending a link via email and/or SMS that enables users to authenticate upon clicking the link, or by entering a code (OTP) that was sent to the users device 302. To start the process a user's device 302 may be prompted by the authentication server 504 at least one time to enter information (email, phone number). Requested information may be used to send a text message/email 304 to said user device 302. For example, a text message or email may be disseminated via SMS or SMTP, optional containing a code that may be used to access a link, or simply a link, to validate a device.

In certain preferred embodiments, upon the device 602 accessing said link via text or email an initial recording/capturing of the user's face may occur. Enabling the passwordless authentication system 604 to associate the user with the previously queried information that serves as a source of truth for authentication capabilities of the system. Preferably utilizing liveness testing/anti-spoofing 122 techniques to mitigate fraud and false positives. A benefit of the present inventive concept is a system that may enable other 3rd party systems to be more secure, by eliminating traditional passwords.

To ensure that facial authentication capabilities of the present system may be consistently robust, at predetermined or organic intervals, a user may be asked to reassess their biometrics or upload a new government. Similarly, to refreshing a traditional password. This may enable the identity management system to maintain an up-to-date depiction and characterization of present system users. Helping to maintain the security of devices, applications, systems; and provide access to processes, permissions, and capabilities of the system and 3rd party systems utilizing the passwordless authentication 600 of the system. The identity management system may continuously learn 106 from facial biometric 102 and identification card 306 inputs that may be consumed in batches, intervals, or continuously. Leveraging machine learning/deep learning 106 algorithms, where learning may occur via backpropagation or other methodologies that may be administered via batch, gradient, stochastic gradient descent, or a combination of the aforementioned.

To mitigate the risk and enhance the security of the identity management and passwordless authentication systems, and systems that leverage the aforementioned for onboarding and authentication from being compromised or hacked, the systems of the present disclosure may utilize account management and monitoring systems 502. The account management and monitoring systems 502 may aggregate data like device and browser classifications, IP location, and VPN detection that may be used to ensure authentication 506-508 attempts occur from a device 302 and location that is trusted. Information may be cross-referenced 108-110, 314 against information 102/306 detected and gleaned by the systems. As an example, if the system of the present disclosure doesn't recognize or validate the device or IP attempting to authenticate the request, or a private VPN is being used to log in for the first time when it typically is not, the attempt may be rejected. A push notification, email, SMS, or combination thereof, may be sent to the registered email or phone number of said user to validate authentication attempts and mitigate nefarious and fraudulent activities.

Securing user accounts from both bots and human attackers has become a fundamental challenge in delivering secure applications and services for governments and businesses that store sensitive information from onboarding and throughout the client lifecycle. Attackers continuously develop more sophisticated techniques for taking over valid accounts, creating fake accounts, abusing trial signups, and loyalty programs. Constantly adapting to evade security controls.

In certain preferred embodiments of the present invention, advanced user behavior models and access patterns pinpoint complex threats that may allow the present disclosures account management and monitoring system to produce actionable insights. Insights may be gleaned over intervals or continuously. The account management and monitoring systems of the present disclosure may track pre—an post-login activity and collect any pertaining events throughout any system to better understand users' patterns. Thus helping to secure critical actions such as account login, profile changes, and various functionality tied to document and transaction management.

The present inventive concept may leverage machine intelligence 106 of supervised or unsupervised nature for analyzing individuals and businesses across a broad spectrum of data points and events, including details about their devices, locations, access patterns, and cookies of the users device 302. The system may monitor each device based on the device type, operating system, browser, user agent, among others. To provide enhanced predictability, users' behavior may be considered. This may include variables comprising access times, geographies of access, account age, and device classifications. It may preferably extend to behavior within the application such as making changes to the account, time of performing certain higher-risk transactions, or virtually any other event in the application or system.

For example, once a bank, brokerage, or municipality DMV collects a user's biometric information and successfully validates those biometrics against a form of preferred identification, that user's image may now be used to access or authenticate a user for service and features within in the entity's website or mobile app. Similarly, a user looking to renew his tabs or driver's license remotely at a DMV. The DMV may verify said user's location and biometrics vs their ID details that have been detected and extracted by the systems OCR, to determine whether they will accept a remote renewal.

Expanding on the previous example, if the user wants to make a transfer out of their bank or brokerage account to another bank or brokerage account (internal or external), the bank and brokerage applications may utilize the passwordless authentication 600 and account management and monitoring systems 502 of the present invention via API or SDK to access the biometric 102 and identity 314 data for verification capabilities 506-508 of the present inventive disclosure. Thus, enabling users to authenticate 506 and process said action(s) or transaction(s) in a secure manner for the entity, without human interaction.

In another example of an embodiment of the present disclosures, a user may launch 600 a desktop/mobile app, or virtual reality (VR) device for a digital bank, brokerage, insurance, investment advisor, crypto exchange, social media, municipality platform in traditional life or the metaverse, and enter their email address, phone number, or both, and receive an SMS, SMTP, in an attempt to start the onboarding process 400 or gain successful access 506 to a system, application, device, servers, and databases of the system or a 3rd party systems.

In certain exemplary embodiments, once a user has been verified by the identity management system, authentication server(s) 504 may assess if the user exists in the database 108 and trigger passwordless authentication flow 602. The device used may receive a nonce 604 from the present disclosures authentication server(s) 504. Once the link is received 602, the user may complete the authentication flow 604 by preferably entering their biometric and/or PIN to unlock the private key. Once biometrics are confirmed 606 the nonce may then be signed with the private key and sent back to the present invention's authentication server(s) 504. The authentication servers 504 may perform public/private key validation 608 and return an access token 512 and provide access to the user 610. By combining data encryption and tunneling protocols, all transmitted data, regardless of device or location, may be completely encrypted at rest and in transit. This level of security may ensure that only authorized connections may be established.

Push notification may be sent 602 to the devices to initiate onboarding or passwordless authentication SDK/API via Apple Push Notification Service on iOS devices, Firebase Cloud Messaging on Android devices, or any push notification system tied to any mobile operating system. For example, the user may receive the push notification and open the app 602. The app may call the present system's authentication server(s) and receive a nonce. The user completes the flow by entering their biometric and/or PIN to unlock the private key 604. The nonce is signed with the private key and sent back to the present disclosure authentication server 606. The authentication server 504 performs public/private key validation and returns an access token 608. The user device may now access the system, device, or application 610.

In an example of the present disclosure's identity management and passwordless authentication systems' unique capabilities, a user may contact support or customer service of a business or government entity using any of the available mediums like phone, message chat, video chat from their device 302. The support agent may pull or query the user's email address or phone number associated with an account and validate against data from a CRM, client master database, the system's database(s), among others. To authenticate the user, the support or virtual agent of the entity or the present system, may trigger 602 the passwordless credential flow. Once verified 604-610, enabling the user to ask more detailed questions of the agent(s) or to proceed with a sensitive transaction or action. Another advantage of an embodiment of the present disclosure is a voice or SMS-powered virtual agent who may ask users to type in an email, phone number, pin, biometrics, prior to optionally speaking with live support staff After successfully validating biometrics 604-608, access 610 to systems, devices, databases, applications, may be facilitated.

In another exemplary embodiment of the present invention, a user may use a QR code (solely or in conjunction with biometrics and/or pin-like functions) to access applications or functions within the system, solely, or in conjunction with another application. For example, a desktop 320 user being onboarded or trying to gain access to an account may be asked to access the app version 320 (via biometrics and/or pin-like functions, traditional password) of the system to continue the onboarding or authentication process by taking a picture of a QR code. For example, an email may be sent with a QR code to the registered email address of a user to be captured by mobile device 320 camera to provide certain access and functionality. The system may allow a user to start their onboarding or authentication process on a desktop and transition to a mobile or vis versa by taking a picture of a QR code associated with their existing onboarding or authentication attempt.

A benefit of the multifactor authentication system 304 of the present disclosures identity management system is a system that may validate and authenticate the email address of a user prior to accepting the email as truth during an onboarding and client lifecycle process. The system may prevent fake, spammy, or mistyped email addresses from being accepted, classifying 320 them by level of risk 316. Data and strings collected from each email address validation attempt may be used independently or in combination with other data collected on the users (IP address, device classification) for classification 320 and predictive purposes. Enabling embodiments of the system of the present disclosure to learn (batches, continuously) via methods of supervised/unsupervised intelligence 106 to optimize classification 320 capabilities and outcomes of the invention.

Among the metadata collected from users' devices 302 when they interact with links and notifications 602 sent by the system is whether a VPN has been detected. Users attempting to gain admission 600 into applications, systems, devices, and/or gain certain access or services that they are not supposed to due to regulatory or country restrictions often try to hide their internet protocol (IP) to disguise their true location. The most common way to do this is using a virtual private network (VPN). Although using a VPN has many practical purposes and advantages, VPN usage may signal a user trying to navigate the web in an incognito manner and may be grouped with other variables for future classifications for predictive insight.

For example, a contract for difference (CFD) broker or cryptocurrency exchange based internationally may unknowingly have clients based in the United States that are illegally using their platform. By leveraging a VPN to mask their location, users may access financial services illegally, as CFDs and some crypto products are banned in the US. Utilizing an unlikely or likely set of variables having learned or preferably continuously learning via machine and deep learning algorithms 106, the system of the present disclosure may determine that 85% of VPN users end up being illegal traders. Providing key insight for compliance and onboarding personnel during future scenarios, thus improving operational efficiency and regulatory compliance.

In exemplary preferred embodiments of the present invention is a multi-factor authentication system 304 that may utilize geolocations and IP addresses tied to a user's device 302 to determine the location of a user to begin the onboarding process 400 and/or periodically thereafter, as may be determined by the system or admin of the system. A benefit of the present inventive concept is a MFA system 304 that may identify the country, region, city, latitude & longitude, ZIP code, time zone, connection speed, Internet Service Provider (ISP), domain name, IDD country code, area code, weather station data, mobile network codes (MNC), mobile country codes (MCC), mobile carrier, elevation, usage type, among other things.

IP addresses including IPv4, IPv6, may be compatible with the present invention. IP location information may be bundled, grouped, coupled, with other data like identification documents 306 stored in the for verification 316-318 and validation purposes. Data/strings collected from each IP address validation, verification, authentication, and the attempt may be used independently or in combination with other data collected on the users for future classification and predictive purposes.

For example, if a user device 302 is being onboarded or logging into the system from a location in South Korea but has a US passport or driver's license, the present invention may inquire about the discrepancy. Registering and storing 108 the user's answer and preferably using them as a determining factor of the present system's identity verification 400 and authentication 600 processes. Expanding on the example, if the user were asked by the system via text, email, or virtual assistant 322, “have you traveled outside of the U.S. in the last 60 days?” A ‘no’ response would raise the user's risk score derived by the classification system 320 due to dishonesty (IP is in South Korea). The virtual assistant 322 may escalate the issue for human interactions or query for more information.

Onboarding data may be stored 322 used to enhance future logins, pre-classify users, classify users, in addition to other key functions and processes. The present invention is one that may optionally enable 3rd party biometrics systems to be integrated with the other identity management systems of present inventions via 3rd party API or SDK to synchronize and create interoperability with the systems document and transaction management systems.

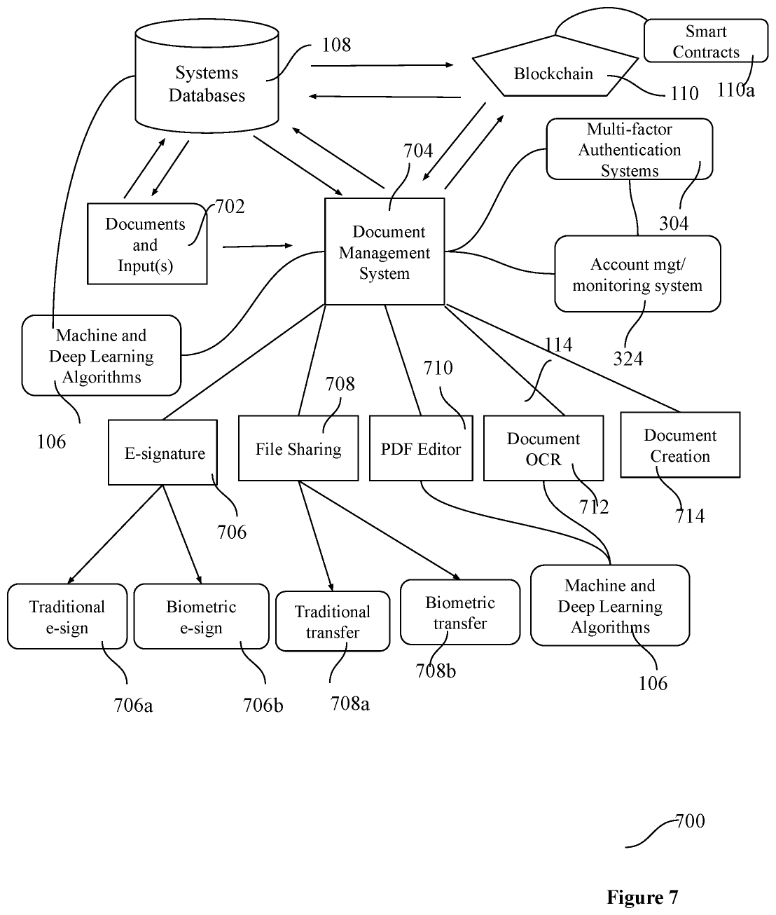

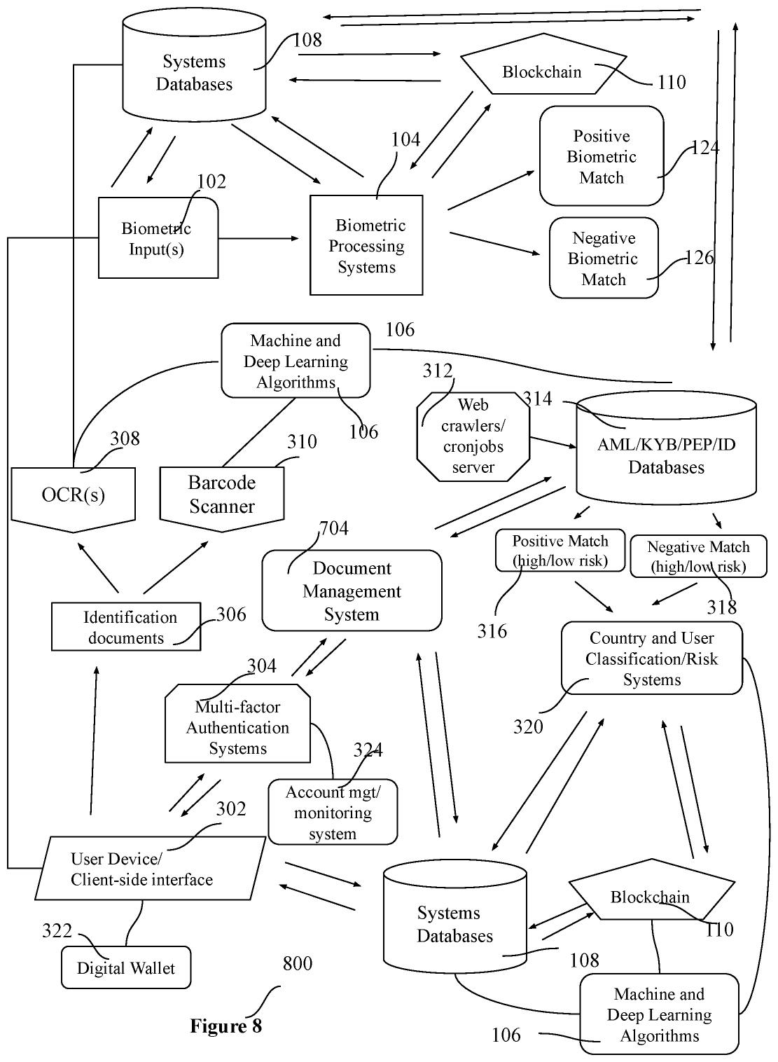

Referring to FIG. 7 is an architecture diagram illustrating document management systems according to an exemplary embodiment of the present invention. An advantage of preferred exemplary embodiments of the present inventive disclosure is an integrated onboarding and client lifecycle management tool that integrates identity and document that may be found in FIG. 8. Once a user's biometrics 124 and identity cards 306 have been verified 124/316 during the onboarding process 400, there is typically a document exchange process 410 that takes place between the user and entity before the user is fully onboarded.

For entities like banks, brokerages, financial advisors, or insurance companies, documents exchanged 410 may be an account opening document or terms of service for the account or loan. For a residential or commercial real estate landlord, this document may be the lease agreement for the property being rented or purchased. For gig-economy companies, this document may be the delivery driver or transportation driver's contractor agreement with the company. For an employer, this may be the employee offer and stock purchase agreement for the employee. For a DMV or other municipality service provider, it may be the annual renewal documents for driver's license or driver's tabs.

A benefit of certain exemplary embodiments of the present invention is a system that integrates identity and document management systems 800 to streamline the reconciliation and display of identity images 102, data extracted by the OCR 308 and/or bar scanner 310, identity documents 306, and the other documents 702 that will inherently be exchanged during onboarding and the client lifecycle. The present disclosure is one that may automatically reconcile, classify, and stored 108 all document shared via eSignature 706 and/or file-sharing 708 capabilities of the document management system 704, in a methodical and systematic manner, with information stored by 108 the identity management system 300 using things like unique identifiers.

The present system may utilize identifiers created by the system and introduced to the system, for automatic reconciliation of document information with identity and document data and metadata aggregated by the systems databases 108/314. In another exemplary embodiment of the present invention, a client-side interface/application 302 may be available that allows the exchange 706-708 of various documents. In preferred exemplary embodiments of the present disclosure, an integrated compliance system may be leveraged, enabling users of the identity and documents systems 800 of the present invention to automate various processes of the client onboarding and client lifecycle process.

For many institutions, this is still a manual process that consists of compliance and onboarding staff sending (physically uploading) a PDF as an email attachment to a user for them to fill out and sign, mailing the document, or faxing the document. These fragmented systems lead to half-hazard document tracking and monitoring, as the documents sent are not automatically linked to the user's identity and transaction profile. Typically forcing manual reconciliation or semi-automatic reconciliation of information. More importantly, it creates bottlenecks in the onboarding and client lifecycle management process, which can lead to unnecessarily long sales cycles and support lead times or an outright loss of the business. More importantly since the systems are independent their audit trails (if they exist at all) may be siloed off.

In exemplary embodiments of the present invention, a document management system 704 may enable users and entities to efficiently exchange 706-708 documents while being onboarded 410 and throughout their lifecycle via the ability to receive/send 708 and digitally sign/exchange 706 legally binding agreements/documents. For example, if an admin of the e-signature system 706 sends user a document, once the document (link) sent via the SMTP of the MFA system 304, metadata about the signatory like device type, browser type, and IP location may be gleaned by the account management system 324 and stored 106. This may enable an entity to ask additional questions to a user who is signing documents from a different location and/or device that has not previously been used to engage the account management and monitoring system 324.

A benefit of an embodiment of the present system is one that may provide admin a defined repeatable (automated) process for exchanging documents 706-708. Helping to ensure that the proper documents are signed/exchanged 706-708 every time, and the recording of such information is stored 108-110 compliantly. Preferably with a preferably immutable audit trail 110.

Furthermore, the client-side interface(s) 302 of an embodiment of the present system document management system may allow users to automatically see the signed documents along with other onboarding system 400 data associated with a profile of the said user. The integrated identity and document management systems 800 may enable admin to print, extract, transfer, export, and download. Another benefit of the present system may be the recording (audit trail) of signed documents on a blockchain 110 via a transaction hash and/or smart contract deployed on the blockchain 110 that may be associated with a signed or successfully transferred document. Thus, providing an immutable audit trail of agreements exchanged between parties.

In preferred exemplary embodiments of the present disclosure the system 704 may serve to continuously send/transfer documents 706-708 and optionally have the documents signed 706. Another advantage of an embodiment of the present system is a smart contract 110a that may have programmable agreements that are sent over a blockchain 110 network that confer and execute the terms of the agreement in a programmable manner. The sender of the document may consider the document as being signed and the agreement consummated once the private/private keys have signed (biometrically or digitally) executing the smart contract 110a agreement.

The document management system 700 may comprise the ability to add text, whiteout text, delete text, comment, highlight, create new fields, checkboxes, underline, stamp, insert and eliminate pages, add signatures, and initials. PDF and other document types of pages may be reordered, rotated, merged, and consolidated. Documents may automatically and routinely be saved and stored over certain intervals to prevent loss of edits—with synchronization preferably happening across multiple devices. The document management system 700 may enable users to annotate and edit PDF documents 710 that may accept various document types including but not limited to .jpgs, .pngs, .pdfs, among others

In an exemplary preferred embodiment of the present inventive disclosure, an immutable audit trail may track every core action within the document management system 700, including but not limited to documents being sent, signed, uploaded, read, and voided. Enabling users of the system to verify and validate all actions of the system in a dynamic and preferably chronological manner and immutable 110 manner. A benefit of the system is that documents may be transferred securely to internal or external users without requesting a signature 708. Another benefit of the present system is one that may enable one or multiple signatories to sign 706 documents. The document management system 700 may allow for documents to be uploaded, dragged and dropped 702, or imported into the system via Dropbox, Google Drive, and other cloud storage vendors 702.

Outside of PDFs, certain preferred embodiments of the present system may be supportive of a variety of document types—DOC, XLS, PPT, PNG, JPEG, DOCX, among others. A benefit of the inventive disclosure is a document management system that may incorporate universal languages. Users of the present disclosure may collaborate 706-708 with entities, each leveraging a client-side interface. Permissions and controls may be set by the account management and monitoring system 324 around documents for internal and external parties. For example, no sharing for internal parties, or 7 days after a contract is sent, if not signed—void. The system may enable users to notarize and otherwise manipulate documents of any type in any manner, without limitation.

A unique benefit of preferred embodiments of the present invention is a system that may enable users to auto-fill documents via API with information that is hosted and stored by the systems databases 108/314 or from 3rd party systems (ex: CRM) that have information pertaining to document(s). Various information about the user signing/transferring 706-708 the document may be acquired during the viewing, transfer, and signature processes, including but not limited to IP addresses, time of opening, last time read, among others. Information aggregated may be cross-referenced against other variables stored in the database(s).

Many times businesses and governments require what are known as wet signatures, the physical signing of a piece of documents. Given the authentication weakness of the traditional e-signature technology, some entities believe this is a way to test the liveness of an applicant—i.e., unique signature. However, this method of delivery is ineffective, error-prone, and outdated. Ironically, many current e-signatures systems are not providing the highest level of integrity to ensure documents are being signed by the right counterparties. Moreover, this dated method of detecting liveness in signors is not adequate to address the concerns of businesses and governments in a dynamic and robust manner.

The automated nature of the present system is one where the documents associated with a type of user (ex: users from China), account (ex: overdrawn accounts), scenario (ex: new accounts), may be sent, delivered, monitored, and audited, in an automated manner without the need to manually selection and upload documents. For example, if an e-commerce company or DMV sends the same documents shared and signed the users onboarding/lifecycle, or different sets of documents for different use cases, they can have these documents automatically fetched and sent through the document management system of the present invention. In this respect, the system of the present inventions document management systems 700 may ensure that no vital documents pertinent for a successful and compliant onboarding or client lifecycle are neglected or require manual sending. A benefit of preferred embodiments of the invention is a document management system that may use SMTP, Bluetooth, QR code, or other forms of data transmission to send and receive documents.

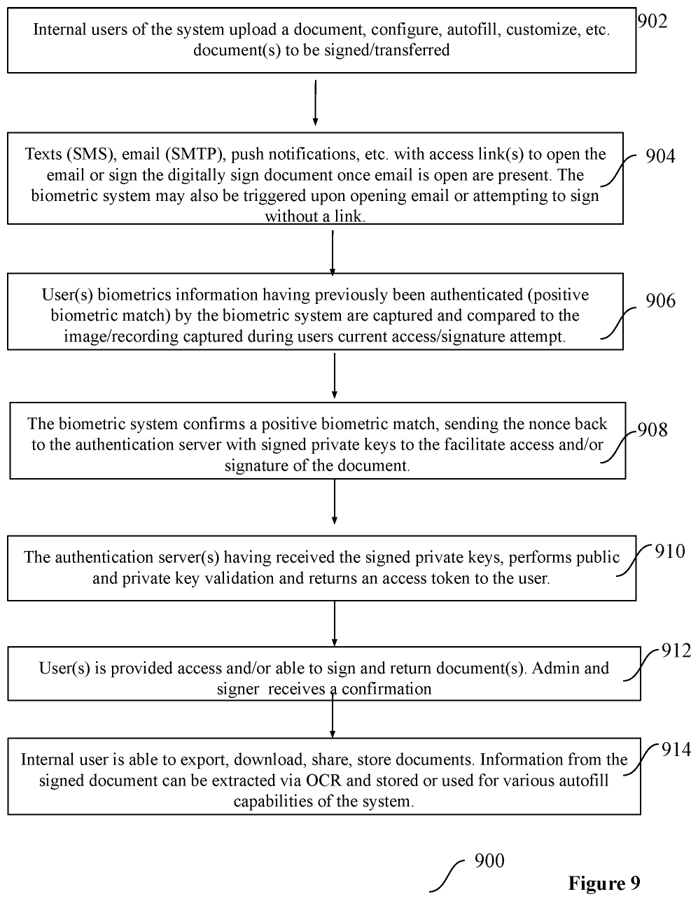

Referring to FIG. 9 is a flow process depicting biometric e-signature and file transfer systems according to an embodiment of the present invention. One advantage of the present invention is a document management system that may utilize data that has been stored in the systems databases 108/314 or blockchain 110 like biometric data and/or image(s) from IDs as an authentication and verification mechanism for documents being e-signed 706b and transmitted for sharing. 708b. The system may optionally use PIN or passwords for access and authentication to documents. Biometric authentication may happen at the beginning preferably, but may be triggered or prompted at the end of the document transfer or signing process. In this way, an entity can confidently send documents to users and ensure that the legally responsible party is verified by the biometric information and other metadata collected regarding the signee. For example, a compliance staff member may transfer documents to an external user that are highly confidential. In this scenario, an embodiment of present disclosure, the present invention may allow for the document to only be accessed by the biometrics of the designated individual(s).

In certain exemplary embodiments of the document management system, a secure file sharing 706 and signature system 708 where XML Digital Signatures, X.509 public keys, PKCS #8 private keys, SHA-512 with 4096-bit RSA keypairs may be present. The present system may utilize security measures including but not limited to, 256-bit AES for data and document encryption, or BCrypt for password hashing. For connectivity security, HTTP, TLS/SSL, SMTP, IMAP, NTP, DNS, etc. may be employed. The system may use methods comprising PIN whether numerical or alphabetical code or a combination thereof, for document access as well. These methods may be used in conjunction or combination with biometric means of authentication.

An advantage of exemplary preferred embodiments 800 of the present inventive concept is that information is extracted via the OCR system 308/712 of the present invention to auto-populate documents being sent or received. For example, during a user onboarding, a bank statement or ID 306 may be uploaded providing information that may be extracted via OCR(s) 308 and stored in the database 108. Information that may be used to auto-populate 702 the agreement form that is signed 706 at the end of the onboarding process 410 with the users information, helping to limit manual data entry errors. Information extracted by the OCR 308/712 includes but is not limited to the first name, last name, address, date of birth, tax information, SS #, EIN, account information, and credit information. Information from signed and returned documents may also be extracted via OCR 712 for various internal processes and sent back to the recipients database via API. Information may be fed to the OCR 308/712 via API or via manual upload (drag and drop).

In a preferred embodiment 700, the OCR 712 is multilingual, enabling smooth usage from a variety of end-users. In addition, information from signed and returned documents may be extracted via OCR 712 and stored in a centralized 108/or decentralized manner 100. A visual depiction of the document may be viewable by the interface 302 of the present system and downloaded or exported in a variety of different formats, securely.

The interconnectedness of certain exemplary embodiments of the identity and document systems 700 of the present invention may be inherent within the present disclosure. Creating a set of systems that may learn from data aggregated across the other systems. This interconnectedness and synchronizations enable the system to automatically remediates onboarding and client lifecycle management issues that are caused by traditionally siloed systems trying to work together, which often lead to manual and cumbersome reconciliation and audit processes that waste time and resources. The audit trail and reconciliation process of the system preferentially executes in real-time but may optionally occur over intervals determined by the system of users of the system, for reasons such as industry or use case. Thus, increasing onboarding and client lifecycle management operational efficiency, economies of scale, and operating leverage.

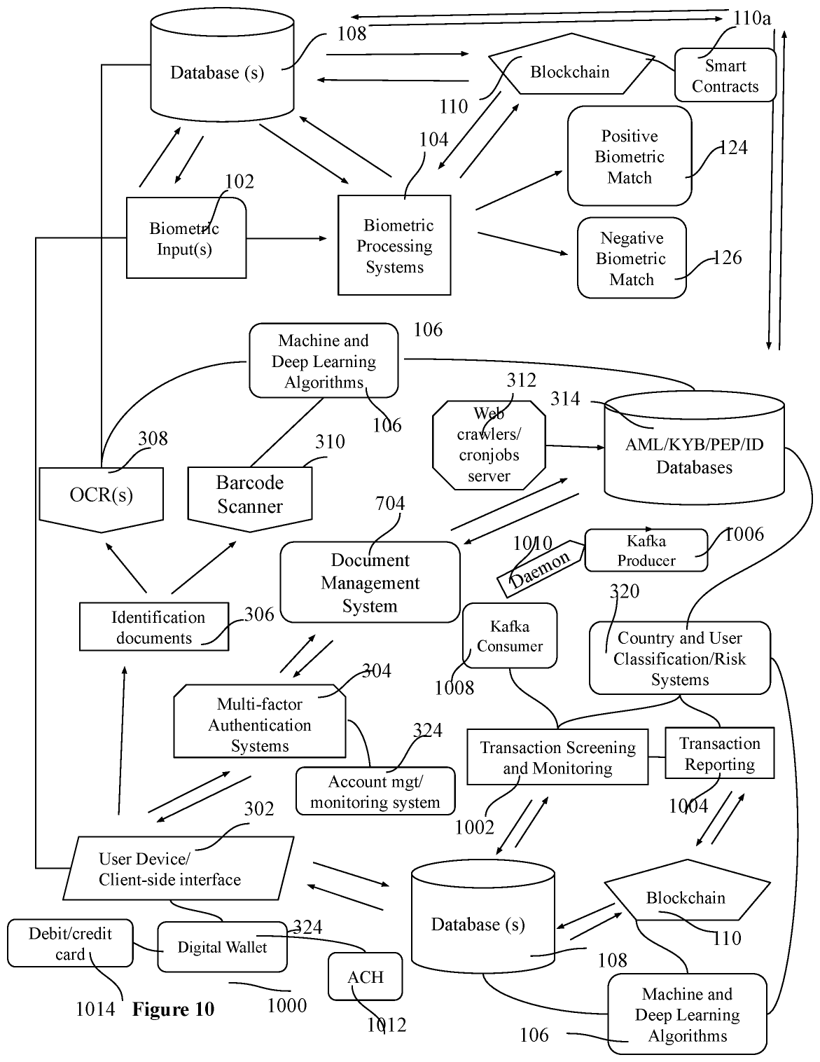

Referring to FIG. 10 is a process flow chart depicting identity, document, and transaction management systems according to an embodiment of the present invention. In certain preferred embodiments of the present inventive disclosure a transaction management system 1002-1004 that may monitor/screen/track 1002 and report 1004 learn from transactional metadata and data comprising transaction value, frequency, type, risk, location, currency, wallet type, asset type, protocol, time/data of transaction. Data and metadata stored may be aggregated 102, stored 108-110, trained 106, and classified 320 in likely or unlikely groups and categories that may be automatically or pre-derived by the system or users of the present system.

A benefit of certain exemplary embodiments of the present invention is a transaction management system that may ingest 108/314 the data previous or currently being aggregated to train (remotely, cloud) models of machine and/or artificial intelligence 106 in intervals or continuously, to allow the system to learn for processes and functions pertaining to transaction screening 1002, fraud detection/prevention 1002, and anomaly detection 106. Data aggregated may be stored in databases 108 on the server(s) of the present system and/or via external databases that may be remote or cloud-based. The databases 108 of the system may leverage SQL and/or NoSQL schemas for storage, wherein databases 108 may contain fixed or variable schemas to define how data is to be stored and categorized by the system. Data may be consumed by the transaction management system in a variety of ways, including but not limited to manual import, API, FTP, and messaging brokers.

In certain embodiments of the transaction management system 1000 is a system that may utilize a data pipeline that ingests transaction data via API and/or messaging broker(s) like Apache Kafka 1006-1008 or RabbitMQ and stores it in the systems databases 108 as transactions are screened and monitored. The messaging brokers 1006-1008 may allow the system to streamline the receipt of information in a websocket fashion. The messaging brokers 1006-1008 of the system may contain a producer (send of messages) 1006 and/or consumer (receives messages) 1008. In certain embodiments, the consumer(s) 1008 may parse transaction data received before storing the data in databases 108. Once parsed, the transaction data may be stored by schema(s) that may be linked to one or more feeds or topics. The producer(s) may be hosted with the present system or hosted by the system of entities that produces the transactional data.

In an exemplary embodiment of the present invention, the consumer 1008 may listen on a topic or feed for transactional data to be sent from the producer 1006, with topics and feeds preferably being predetermined for schema aligned for seeding in the database 108. The producer 1106 may optionally be hosted at the backend of the system and synchronized with the admin client-side interface of the present system. In these embodiments, an import function may be observed that enables users to transmit transaction data into the system via import. In anticipation of transmitting transaction data to the producer 1006, the client-side 302 interface may be used to ensure data is being sent in an acceptable format. A benefit of the present system is that daemon 1010 may be present that may use reconcile and transactions that may have been missed by the consumer 1008 or not sent by the producer 1006. The daemon 1010 may alert the producer 1006 that certain information was not successfully posted to the consumer 1008, thus enabling the producer to resent the missing transaction data.

The database 108 serves to analyze and audit the file type to ensure all the data being imported meets the criteria and is seeded properly. The present disclosure may utilize a conversion function (algorithm) to transform data imported via different file types (csv, tsv) into json format prior to transmitting the transaction data via the producer to the consumer. Once the data has preferably been converted, an API may be used to communicate with the producer 1006, before sending the information from the producer to the consumer 1008.

In the event NoSQL database(s) are being used, the data transmitted may be replicated across multiple databases 108-110. After the information has been stored, a hash of the information may be created. The distributed ledger 110 of the system may be used to store the metadata and/or data in a preferably immutable fashion. The system may also store a hash on-chain with transaction data being stored off-chain 108. In another exemplary embodiment, the system may use a client-facing API to enable entities leveraging the system to POST information into databases 108 tied to the system. API calls may also be used to GET information from the system. All endpoints of the system utilize authentication like OAuth, JWT, API, or some combination of the 3. In certain embodiments, systems APIs or APIs that interact with the system may utilize JSON Web Token (JWT) to authenticate other API requests, or preferably JWT with OAuth for higher security. External APIs may utilize API keys in their request to authenticate requests with the system.

In an embodiment, the consumer broker 1008 may be hosted on the backend of the client-side interface 302. A producer 1006 may send messages to the consumer broker 1008, where the consumer broker 1008 may listen on topics tied to the transaction monitor/screening 1002. Once received, the data may be parsed by the consumer and subsequently seeded into the transaction monitor 1002 and database 108 of the application for further utilization by the present disclosures transaction management system. The system may fetch transaction and financial information and data regarding a client via 3rd party APIs and SDKs like investment account holding or the balance in a user's account. This financial information may be used in conjunction with information contained on the user by the system to provide a holistic view of their financials.

One benefit of the transaction management system of the present invention is that it may recognize various forms of transactions and transaction types. For example, in real estate applications of the system, transactions may be tied to rent and security deposits being paid. For credit card companies, transactions may be tied to debits and credits made by users. An insurance company's transactions may be linked to premium payments made by users. While a bank, brokerage, exchange, virtual asset service provider (VASPs), ecommerce, or payments company may have transactions tied to buying, selling, transferring, withdrawing, depositing, execution, clearing, and settlement of assets, funds.

In one exemplary embodiment of the transaction management system, where brokers, exchanges, and VASPs may be concerned, FIX APIs may be used to seed information into the systems databases 108-110. In another embodiment. for banks and other companies that process payment, SWIFT/ISO APIs may be utilized. In scenarios where FIX APIs are used, initiator (sends messages) and acceptor (receives messages) FIX engines may be present, allowing the system to digest data leveraging the FIX protocol. These engines behave very much like the Kafka producers 1006 and consumers 1008.

Another benefit of exemplary embodiments of the transaction management system of the present invention is that it may recognize various forms of asset types. The system is one that may track and screen 1002 both traditional assets and digital (virtual) assets. Assets tracked by the system may be hosted in centralized or decentralized forms. The transaction management system may utilize blockchain transaction data that is sourced by running a node of the respective blockchain, or by via a 3rd party websockets or APIs that provides the system with information from blockchain.

For example, in one embodiment an entity may POST metadata or data related to a blockchain transaction in database(s) 108 associated with the system. The metadata from the transaction like blockchain type (Ethereum), token type (Chainlink), and wallet address. This information can be used to query a 3rd party API to GET the transaction information directly from the Ethereum blockchain, before POST that information to the database 108 tied to the transaction management system of present disclosure. In another example, a node of the system that is running the either network may listen for transactions tied to wallets monitored by the system and seed the database 108 with the transaction data fetched from the node running the blockchain network 110.

In preferred embodiments of the present invention, transaction monitoring and screening 1002 processes and functionality may be observed. Thus, allowing entities using the transaction management system 1006-1008 to ensure they are facilitating compliant transactions. The system may rank and classify 320 transactions based on various criteria's that may be generated from a likely or unlikely set of variables, including but not limited to a user onboarding risk score, country risk score, transaction frequency, transaction amount, and transaction type. A benefit of the present system is one where an audit trail (preferably immutable) is created for all transactions.

The criteria for determining risk may be rules and logic-based 320, generated by users of the system or automatically by the system. In scenarios where the former is utilized, entities may set predetermined thresholds allowing notifications to be distributed via SMTP, SMS, API, webbook, etc. once or prior to a transaction criterion being breached. Transaction thresholds may be set globally, regionally, or by country and state. As each classification may have different thresholds that trigger some form of reporting. In an example of the system's unique and integrated nature, transactions that breach certain thresholds may be halted until a user goes through the passwordless authentication flow of the system to verify their identity.

A benefit of preferred embodiments of the present inventive concept is a transaction management system capable of detecting different typologies 106 and mitigating false positives during the transaction monitoring and screening 1002 process. The system may use supervised and/or unsupervised artificial intelligence 106 to better identify false positives. Another benefit is a transaction management system capable of positive identifying known money laundering typologies including but not limited to fan-out (single sender and multiple receiver accounts), fan-in (multiple sender and single receiver accounts), scatter-gather (main account distributes money to several members and members send most of the received money to a single account), stacked bipartite, bipartite, etc. via machine intelligence 106. The system may also identify unknown patterns via unsupervised machine learning 106.

In FIG. 10 an exemplary embodiment of the present inventive disclosure may utilize identity, document, or transaction data contained and/or extracted from centralized 108 or distributed ledgers 110 to train supervised and unsupervised forms of machine intelligence 106 may use heavily GPU-powered (remote, cloud.) systems. In an embodiment of the present disclosure, aggregated information may be grouped, labeled, and stored for training. Ideally, splitting the data into a testset and training set for learning purposes via backpropagation (or other methodologies) being administered via. batch, gradient, stochastic gradient descent, or a combination. The present system stores messages and requests, and uses classification 320, clustering, and other types of supervised and unsupervised algorithms 106 to create various bundles, groups, layers, or information to optimize the identity, document, and transaction management systems 1000. Cached information may be leveraged to improve the performance of the system across a variety of processes.

In a preferred embodiment of the present system, to manage and automate compliance reporting tied to transactions, the transaction reporting system 1004 of the present inventions transaction monitor may automatically file Suspicious Activity Report (SARs) and Counter-Terrorism Report (CTR) with FinCEN and other regulators. The present invention may provide a front-end interface 302 where client(s) transactions may be visualized in a dashboard interface. This may enable entities to manage their SARs reporting in a concise manner. The system may auto-fill parts of the SAR/CTR/Travel Rule forms via API leveraging information extracted during the onboarding phase 400 like first and last name, address, DOB, address, among others.

The present inventions reporting capabilities may also enable entities to report transactions 1004 for users. For example, residential real estate companies, credit card companies, and insurance companies that utilize the system may report transaction information to credit rating agencies to enable the people using their platforms to build their credit once transactions have been successfully processed. As another example of exemplary embodiments, brokerages, exchanges, and VASPs that utilize the system may use FIX API to report transactions to various trade reporting facilities using an initiator FIX engine to send messages and an acceptor to receive confirmations.

The client-side interfaces 302 of the system provide user interfaces for both admins of the system and users of the system to share and view information tied to the identity, document, and transaction management 1000 capabilities of the system. The admin interface enables admins to view, edit, add, delete, approve, reject, import, and export identity, document, and transaction information. Admin panel information may comprise cumulative financial data about clients, overview of total investments, performance and allocation data for assets and portfolio, investing plans, investment policy statement, recent activities of clients, a timeline of client notifications, client investments and transactions. The admin panel may group users of the system by various categories using classification from the system 320 like risk type, country, user score or other statuses to segment users and enable entities to manage their users and their data accordingly.

In certain exemplary embodiments of the present disclosure, an admin panel interface where users that are approved, pending, or rejected by the identity management system may be found. A benefit of preferred embodiments is a admin panel that may display users data, enabling the admin to sort (in ascending order or descending order), filter by document type 306 uploaded (drivers license, passport, national ID), status (rejected, pending, approved, escalate), country risk score, user risk score, date submitted, first and/or last name.

Secure in nature, the present system supports different users for entities like super admin, admin, admin-member, and members. Providing backend controls and configurations based on user, department, or function. For instance, an admin may be the only one with the ability to delete a user or change a user's status or provide certain permissions to other admins that are invited. Furthermore, the login activity, location, and device classifications of the present system may empower the monitoring of access to the admin panel changing of other sensitive information.

In certain exemplary embodiments of the present inventions transaction management system, the entities utilizing the system may initiate financial transactions on a user's behalf via FIX API or other APIs utilized by the system for communicating trading instructions. For example, an investment advisor may initiate a buy or sell order on behalf of their client, where the FIX initiator utilized by the system may be used to communicate order instructions with the acceptor engine of the venue executing the financial transaction. The admin panel may enable the entity to track and manage the execution, clearing, and settlement of the transaction, in addition to any reporting to trade reporting facilities that may be associated with the transactions.

In addition, this user portal may enable the user to communicate with the admin to make requests and share certain information, whether it be documents that need to be signed via eSignature 706 or shared via File Sharing 708. Users may initiate payments via digital wallet 324 to entities in the user portal. Payment may be via traditional means like debit/credit 1014, wire, and ACH 1012 using APIs and SDKs of the system or 3rd party solutions. The client interface 302 and desktop application 302 may be synchronized with the digital wallet 324. For example, a tenant of a real estate company may make a maintenance request in his user portal 302 and pay his rent. These transactions and requests would be communicated and displayed in the admin portal.

Comprehensive in nature, the system of the present invention enables members of an organization to communicate in real-time. Attributes and functionality of the chat system include location detection, last seen, message read, among others. 3rd party chats APIs and SDKs may also be integrated to work in conjunction with the system of the present disclosure to optimize usability via integrations. In addition, the system may come with external chat support or utilize 3rd party integrations.

A benefit of preferred embodiments is an alert system that may work in real-time, alerting/notifying internal and external users of the system on processes related to emails, pending applications, deleted account, transaction size, fraud detection, filing regulatory documents, etc. Alerts of the system may be inherent or rules-based, proving the flexibility needed for a variety of different users across a variety of different industries. Alerts of the present system may trigger system actions, 3rd party system action, physical action from internal and/or external users; or may simply notify users to actions by the system or 3rd party systems, or the completion of an action by the system or 3rd party. Furthermore, messages may be transmitted via various message protocols like webhook, SMTP, SMS, MIMS, and API.

In certain exemplary embodiments of the present inventive disclosure, the system data may be stored on a distributed ledger/blockchain 110 to improve data transparency, security, and immutability. The blockchain(s) 110 utilized by the system may be private, consortium, or public blockchain networks or a combination of the aforementioned. Communication and storage between multiple blockchain systems may be possible via rollups, side chains, etc. helping to provide interoperability.

In another exemplary embodiment of the present disclosure, RPC APIs and other methods may be present and used to GET and POST metadata/data on a blockchain 110. This data may be efficiently sorted, grouped, categorized, bundled, and retrieved for compliance and regulatory purposes. A benefit of the present disclosure is a system that saves a hash of the transaction data on-chain while saving the sensitive data off-chain to meet data protection and privacy concerns created by regulation like GDPR, CCPA, ISO 27001, SOC2, among others. Off-chain data 108 may be converted into the original hash saved on-chain 110 to ensure the off-chain 108 data integrity

In certain exemplary embodiments of the present invention is a blockchain-based 110 (distributed ledger) system where a protocol(s) and consensus algorithm(s) may be present. Transaction, document, and identity data, metadata, and/or hashes may be replicated on nodes across a private, consortium, public network, or a combination. Within the system of the present invention, consensus may be managed by a set of nodes hosted by users or entities. To validate transactions within the network, a group of predetermined or authorized nodes (computers, laptops, servers) may be observed. In certain embodiments, to maintain anonymity for users of the present disclosure, only predefined nodes may be able to view the total aggregated content of the blockchain ledger. Data may be preferably distributed among nodes of the network creating an immutable audit trail.

Platform users may have an option to run different types of nodes (master, full, light). A master node may have multiple functions within the system of the present disclosure, including but not limited to validating transactions, creating new blocks, managing voting events, governance, providing execution of protocol operations, among others. Masternodes may be online 24/7, as a result, they require more maintenance, storage space, and memory. Hosting a masternode may enable entities to earn interest on stakes and for validating transactions. In order to run a node(s), an entity may be required to deposit a minimum amount of fiat, digital, virtual, crypto currency as collateral. Collateral may be seized in the event a node violates the rules of the blockchain. Entities of the present invention may run full nodes or light nodes. Full nodes contain a full copy of the blockchain's 110 transaction history, while light nodes may contain a segment or portion of the blockchain's 110 transaction history.

Once validated, data may be grouped into blocks and stored on-chain 110. Nodes of the system may be connected and constantly exchange the most recent blockchain data, ensuring all nodes stay up to date. Once a validator (master) node accepts a new block of transactions, it is added to the existing blocks. Nodes can be online or offline. Online nodes (typically master and full nodes) receive, save, and broadcast the latest blocks of transactions to other online nodes. When an offline node comes online, it may download all blocks that were added to the blockchain 100 since the node went offline to synchronize with the other nodes.

The sequential linking of blocks within the systems blockchain(s) 100 ensures immutability and the information contained therein. For each entity running a node of the ecosystem, a copy or partial copy of all transactions may be readily available. Private smart contracts may enable data to be encrypted ensuring anonymity for users, wherein participants may only view metadata pertaining to the said participant. Entities may control access to ledger data at a department, function, regulator, employee, and user permission level. Ensuring a variety of end-users access to a single source of truth. Each transaction recorded and stored within blocks on the blockchain may be time-stamped, creating an immutable trail for entities of the network to monitor, account, and extract historical information from the distributed ledger through a variety of compliance reporting related queries. Preferably disseminated geographically, nodes of the system run a copy of the network blocks (transactions), creating highly secure, transparent, and dependable record keeping.

In an exemplary embodiment of the present inventive concept, identity, document, and transaction information of the system may be distributed across a multitude of nodes that may be incentivized to validate transactions (information) and create a new block aggregated with the transactions (information). Each block of the chain of the present system is linked cryptographically. Data and metadata of the blockchain may be encrypted using the most advanced security measure (SHA256) to maintain anonymity for counterparties transacting on the network. Each node(s) (master, full, light) may be hosted strategically using machines of supervised and unsupervised intelligence to minimize network costs and maximize geographical distribution, while maintaining optimal scalability and security. In one embodiment of the present invention is a frontend interface where entities can view prebuilt standardized reports or create their own based on queried data from the distributed ledger/blockchain to streamline compliance and regulatory process may be present.

Once a new block of validated transactions is minted, that information may be communicated to nodes throughout the network. A benefit of the present invention is a blockchain where smart contracts (programmable contracts) 110a may be utilized for storing identity, document, and transaction information or a hash said information on the blockchain 110. To ensure anonymity and privacy for transactors of the system, on-chain cryptographic mechanisms like private smart contracts, ring signatures, stealth addresses, mixing, may be utilized. To protect on-chain and/or off-chain data, cryptographic tools like zero-knowledge proofs, zk-SNARKS, Pedersen commitments may be leveraged. Off-chain 108 privacy layers like trusted execution environments (TEEs) may also be present.

In certain exemplary embodiments the present inventions identity, document, and transaction management systems 1000 may function in conjunction with a digital wallet 324. The user portal 302 may be synchronized with the digital wallet 302 of the present disclosure. Giving the user mobile and desktop usability and management of their identity, document, and transaction information. The digital wallet of present disclosure may be used to control and custody assets that are tokenized and digitized on the systems blockchain(s) 110 or other blockchains. The wallet 324 may have a private and/or alphanumeric key used to sign transactions prior to initiation. The alphanumeric key may also be used to import existing wallets into the digital wallet 324 of present disclosure. Said digital wallets 324 may have a public wallet address that may be used to identify and transact with them. The wallet 324 may have payment functions (sending/receiving payments, paying fees, receiving rebates/returns), trading functions (buy, sell), and clearing/custody functions (margining, escrow, multi-signature), among other things.

Another advantage of certain embodiments of the digital wallet is that it may hold information or a derivative (hash) of information from identity 300 and document systems 700, For example, biometric information 702 may be stored as is, in a hash, or otherwise linked to the wallet 324 via methods comprising smart contracts 110a and QR codes to authenticate transaction based activities and transactions. Identity information 314 may also be used to authenticate a user for decentralized applications and protocols that facilitate lending and borrowing. Once verified users may interact with these (semi) permissioned protocols via the system's digital wallet 324 or another wallet tied to that protocol. A benefit of the system's wallet 324 is that it may interact with programmable contracts 110a of the system and across various blockchain and smart contracts, without limitation.

The digital wallet 324 of the present invention disclosure may be utilized when assets are digitized and/or held in the systems blockchain 110 and smart contracts 110a, or when the underlying assets are held outside of the system but may be under the control of the system in some capacity via permission of the user. The digital wallet 324 be used to reflect assets held in a traditional account, enabling the assets in the traditional account to be digitized/tokenized on-chain to utilize the various functionality and processes of the digital wallet. Assets held off-chain may be in escrow or multi-signature type accounts, or otherwise within control of the present disclosure via permission or authentication methods employed by the system or 3rd party API and SDKs utilized by the system. Thus, allowing the system to control assets held off-chain to properly reconcile with on-chain activity.

The digital wallet of the present inventive disclosure may preferably be linked with digital or physical debit/credit cards 1014 to enable use in commercial transactions in-person, online, or in the metaverse. Payments transmitted via the digital wallet card 1014 may be made in traditional or digital (crypto) currencies. Different trading, payment, suspicious, or credit building transactions (paying rent, paying insurance premium, credit card payment) made via desktop/digital wallets 302/324 of the system tied to the user portal 302, or by cards 1014 tied to the aforementioned may be reported 1004 to regulators or credit rating agencies via methods like APIs. An advantage of the digital wallets 324 of present invention are wallets that may be custodial or non-custodial in nature.

As an example of the exemplary preferred embodiments and the interconnected nature of exemplary embodiments of present inventive disclosure, a credit card company may use the identity management system to onboard the user, and the document management system for sharing and getting the account opening agreement signed by the user. Once the user is onboarded they may be provided a desktop (cloud, application) and/or digital wallet to manage and monitor future identity, document, and transaction related activities. The payment or credit card company may provide the user with a credit or debit card that is tied to the digital wallet and enables the user to facilitate payments/transactions via traditional or digital currencies. Once the user makes successful monthly payments to the credit card company, their payments may be reported to credit rating agencies and any change to a user's credit rating may be directly reflected within the transaction management systems digital wallet.

In certain preferred embodiments of the present invention, the transaction management system of present disclosure may use an Automated Clearing House (ACH) 1012 system to facilitate the origination and processing of payments made via the digital wallet 324, cloud, or desktop applications of the system. The ACH system 1012 preferably enables users to send money from their bank accounts using their routing number and account number. The ACH 1012 system utilized by the transaction management system may authenticate users from information provided or extracted during the onboarding process.

Furthermore, the system may use internal or 3rd party APIs and SDKs like Plaid and Yodlee to fetch users' financial information directly from their account that may include a user's routing and account information to facilitate payments. This may enable the system to ascertain the balance of a user account in real-time, thus allowing the user and system to facilitate secure payment settlement for users of the system.

Another benefit of the wallet is that it may serve as an identification mechanism for traditional means of identification or in metaverse applications. For example, a DMV may use the identity management system of the present inventive concept to onboarding a user and authenticate their identity for driver's license renewal. The DMV may use the file sharing and e-signature capabilities of the document management system to exchange the necessary motor vehicle registration documents with the user to get their digital signature and commitment. The DMV may then issue a digitized driver license to the digital wallet that may be used in the traditional world or metaverse for identity verification. The passwordless authentication system may be used to access the digital wallet.

In an exemplary embodiment of the present invention, information collected, derived, or generated during the onboarding process 400 that was used to create classifications of a user may be leveraged for by the digital wallet of the present disclosure for decentralized lending and trading protocols for (semi) permissioned onboarding. Enabling them to vet users without taking on the onboarding and client lifecycle responsibilities of the system. These protocols may leverage the various classifications generated by the system.

For example, on-chain 110 and off-chain 108/314 information aggregated on the user by the identity (ex: biometrics/government ID), document (ex: tax documents), and transaction (ex: bank account and crypto wallet balance) management system may be used via machine intelligence of supervised or unsupervised 106 means to create an idea of the financial credit or trust worthiness of a particular user. This information may be classified 320 and communicated using variable(s) like credit scores, trustworthy scores, etc. A benefit of the present invention is a system that may use on-chain 110 and off-chain 208 data to get a more holistic view of a user's profile, allowing users of decentralized protocols to better understand who they are transacting with, while still maintaining user anonymity for the underlying protocol.

It may be apparent to one with skill in the art that the synchronized and integrated identity, document, and transaction management systems may be provided using some or all the mentioned features and components without departing from the spirit and scope of the present invention. It may also be apparent to the skilled artisan that the embodiments described above may be specific examples of a single broader invention that may have greater scope than any of the singular descriptions expressed. There may be many alterations made in the description without departing from the spirit and scope of the present invention.

What is claimed is:

1. An identity, document, transaction management system for automated onboarding, compliance workflow, and client lifecycle management comprising:
biometrics systems of supervised and/or unsupervised intelligence, said system may support various biometrics types, preferably utilizing facial biometrics comparison for compliance onboarding; image compared may be an image/recording of an identification card, credentials being physical and/or digital, gender, age, ethnicity, anti-spoofing, liveness component being present;
identification systems and databases where IDs may be stored, utilizing security features comprising UV, infrared, holograms, watermarks unique to a specific ID type may be learned, enabling classification and validation; securing the credibility of authentication/onboarding processes, wherein web crawlers and cronjobs may be used to scrap, populate, update a database(s) automatically;
a passwordless authentication system utilizing authentication server(s) that may upon request send a nonce to another system, devices, applications, utilizing biometrics for validating and unlocking private keys to sign a nonce, communicating with the authentication server(s) for private and public key validation, access token(s), enabling users to set/reset biometrics manually, said system may also refresh authentication credentials over a fixed, predetermined, random time, continuously providing robust authentication services;
authentication server(s) that may preferably be queried to access or sign a document, file, etc., sending a nonce to the requesting system, devices, applications, previously approved biometric(s) may be utilized for validating and unlocking private keys to sign a nonce; communicating with the authentication server(s) for private and public key validation, returning an access token(s) upon confirmation; enabling the document to successfully be accessed, signed;
an account management and monitoring system leveraging supervised and/or supervised algorithms; wherein additional system(s) generate IP location, VPN, device classification, cookies information, for grouping, bundling, clustering, thwarting threats, optional enabling users to set/reset biometrics manually, said system may also refresh authentication credentials over a fixed, predetermined, random time, continuously providing robust authentication services;
a multi-factor authentication system comprising biometrics, QR codes, PIN codes, links, may be sent via SMTP, notification, and/or SMS;
optical character recognition (OCR) systems utilizing at least one neural network (LSTM); line recognition and character recognition may be present, enabling information to be extracted from documents/identification, optionally queried against AML/KYB, PEP databases, auto-filling documents fields, linked to an e-signature and transfer system;
barcode scanner system where codes comprising PDF417, QR code, code 128, code39, EAN 8/13, UPC A/E, etc. may scan and extract information, optionally queried against AML/KYB/PEP databases, auto-filling documents fields, linked to an e-signature and transfer system;
a classification system utilizing variables that may be comprised from the Financial Action Task Force (FAFT) in gauging AML risk, country risk scores and individual risk score(s), said system optionally using algorithms of the machine and deep artificial intelligence in adjusting scores for classifying and predicting;
an alert/notification system wherein real-time and/or rules-based alter system may be present, empowering timely response and/or notification, integrated with an identity, document, and transaction system;
a storage system, enabling storage on centralized and/or distributed systems, wherein a private, consortium, and/or public blockchain is present storing information on-chain or off-chain, a hash of onboarding, transaction, document data may be saved on-chain, optionally, sensitive information off-chain, said blockchain may be compatible with a digital wallet that may facilitate transactions via ACH, optionally utilizing a debit/credit card;
a document management system employing an electronic file transfer/signature system, optionally using biometrics to authenticate when sending/transferring client documents; optionally enabling signature, said system(s) preferably leveraging IP location, VPN, device classification, for authentication and system learning, a file management and upload system, enabling users to upload, edit, configure, download, share, sending server where SMTP may be used for sending emails; 3rd party SMTP functionality may be integrated, optionally utilizing FTP for larger documents and file types;
and a transaction monitoring/screening/reporting system capable of detecting different typologies and mitigating false positives via machine intelligence is utilized, storing transaction data (or a hash of data) on-chain and/or off-chain, wherein certain transactions may trigger automatic regulatory or credit reporting.

2. An identity and document management system for automated onboarding, compliance workflow, and client lifecycle management comprising:
a biometric(s) system of supervised and/or unsupervised intelligence, utilizing biometrics from an initial onboarding; wherein various biometrics types comprising facial, fingerprint(s), may be employed; gender, age, ethnicity, anti-spoofing, liveness component may be present, optionally leveraging a variety of sensor types comprising optical, capacitive, ultrasound, thermal for collecting fingerprint surface, matching techniques comprising minutiae-based matching, pattern matching,
identification systems and databases where IDs may be stored, utilizing security features comprising UV, infrared, holograms, watermarks unique to a specific ID type may be learned, enabling classification and validation; securing the credibility of authentication/onboarding processes, wherein web crawlers and cronjobs may be used to scrap, populate, update a database(s) automatically;
a passwordless authentication system utilizing authentication server(s) that may upon request send a nonce to another system, devices, applications, utilizing biometrics for validating and unlocking private keys to sign a nonce, communicating with the authentication server(s) for private and public key validation, access token(s).
an authentication server(s) that may preferably be queried to access or sign a document, file, etc., sending a nonce to the requesting system, devices, applications, previously approved biometric(s) may be utilized for validating and unlocking private keys to sign a nonce, communicating with the authentication server(s) for private and public key validation, returning an access token(s) upon confirmation, enabling the document to successfully accessed, signed;
optical character recognition (OCR) systems utilizing at least one neural network, line recognition and character recognition may be present, enabling information to be extracted from documents/identification, optionally queried against AML/KYB, PEP databases, auto-filling documents fields, linked to an e-signature and transfer system;
a barcode scanner system where codes comprising PDF417, QR code, code 128, code39, EAN 8/13, UPC A/E, may scan and extract information, preferably queried against compliance databases, auto-filling documents fields, linked to an e-signature and transfer system;
a classification system utilizing variables that may be comprised from the Financial Action Task Force (FAFT) in gauging AML risk, country risk scores and individual risk score(s), said system optionally using algorithms of the machine and deep artificial intelligence in adjusting scores for classifying and predicting risks;
a document management system employing an electronic file transfer/signature system, optionally using biometrics to authenticate when sending/transferring client documents; optionally enabling signature, said system(s) preferably leveraging IP location, VPN, device classification, for authentication and system learning, a file management and upload system, enabling users to upload, edit, configure, download, share, sending server where SMTP may be used for sending emails, optionally 3rd party SMTP functionality may be integrated;
an account management and monitoring system leveraging supervised and/or supervised algorithms, wherein additional system(s) generate IP location, VPN, device classification, cookies information, for grouping, bundling, clustering, thwarting threats, optional enabling users to set/reset biometrics manually, said system may also refresh authentication credentials over a fixed, predetermined, random time, continuously providing robust authentication services;
a multi-factor authentication system comprising biometrics, QR codes, PIN codes, links, may be sent via SMTP, notification, and/or SMS;
an alert/notification system wherein real-time and/or rules-based alter system may be present, empowering timely response and/or notification, integrated with an identity, document, and transaction system;
a storage system, enabling storage on centralized and/or distributed systems, wherein a private, consortium, and/or public blockchain is present storing information on-chain or off-chain, a hash of onboarding, transaction, document data may be saved on-chain, optionally, sensitive information off-chain, said blockchain may be compatible with a digital wallet.
